(19) United States
(12) Patent Application Publication
(10) Pub. No.: US 2021/0229956 A1
(43) Pub. Date: Jul. 29, 2021

(54) COMPOSITE ELEVATOR BELT AND METHOD FOR MAKING THE SAME

(71) Applicant: thyssenkrupp Elevator Innovation and Operations AG, Essen (DE)

(72) Inventor: Frank Dudde, Collierville, TN (US)

(73) Assignee: thyssenkrupp Elevator Innovation and Operations AG, Essen (DE)

(21) Appl. No.: 17/250,127

(22) PCT Filed: Nov. 22, 2018
(86) PCT No.: PCT/EP2018/082168

§ 371 Date: Dec. 2, 2020

(30) Foreign Application Priority Data
Jun. 6, 2018 (EP) 2018064854

(51) Int. Cl. B66B 7/06; D07B 1/16; D07B 1/22

(52) U.S. Cl. CPC B66B 7/062; D07B 1/162; D07B 2201/2087; D07B 2501/2007; D07B 2201/2092; D07B 1/22

(57) ABSTRACT

A composite elevator belt for engaging a sheave includes a load carrier having at least one load carrier strand extending substantially parallel to a longitudinal axis of the load carrier and a resin coating surrounding the at least one load carrier strand and defining a plurality of predetermined, deformable cavities within the resin coating adjacent the at least one strand. When the elevator belt is bent around the sheave, the elevator belt defines a neutral bending zone located within the elevator belt generally coincident with the longitudinal axis, a tension zone radially outward of neutral bending zone, and a compression zone radially inward from the neutral bending zone.

### BACKGROUND OF THE INVENTION

### Field of the Invention

The present disclosure is generally directed to composite elevator belts for use in lifting and lowering an elevator car. More particularly, the present disclosure is directed to composite elevator belts having, for example, a load carrier including a central layer and at least one outer layer, each outer layer defining a plurality of deformable pockets to reduce or neutralize tension and compression loads within the composite elevator belts. The present disclosure is also directed to methods for making composite elevator belts.

### Description of Related Art

Elevators for vertically transporting people and goods are an integral part of modern residential and commercial buildings. A typical elevator system includes one or more elevator cars raised and lowered by a hoist system. The hoist system typically includes both driven and idler sheave assemblies over which one or more tension members attached to the elevator car are driven. The elevator car is raised or lowered due to traction between the tension members and drive sheaves. A variety of tension member types, including wire rope, V-belts, flat belts, and chains, may be used, with the sheave assemblies having corresponding running surfaces to transmit tractive force between the tension members and the sheave assemblies.

A limiting factor in the design of current elevator systems is the minimum bend radius of the tension members. If a tension member is flexed beyond its minimum bend radius, the compressive forces within the tension member may exceed the breaking strength of the tension member material, or may cause the material to buckle and fail. Continuous operation of the tension members below their minimum bend radii can cause fatigue at an increased and unpredictable rate and, under extreme circumstances, may result in a plastic deformation and failure. Thus, the minimum size of the sheaves useable in an elevator system is governed by the minimum bend radius of the tension members.

For several reasons, sheaves having a smaller diameter allow for more economical elevator system designs. First, the overall component cost of an elevator system can be significantly reduced by using smaller diameter sheaves and sheave assemblies. Second, smaller diameter sheaves reduce the motor torque necessary to drive the elevator system, thereby permitting use of smaller drive motors and allowing for smaller hoistway dimensions. Additionally, decreasing the bend radius of the tension members generally permits easier installation and decreases the spool size of the tension members.

Accordingly, minimizing the bend radius of elevator tension members and, conversely, increasing tension member flexibility is desirable. Among current tension member designs, composite belts having fiber or wire strands encased in a resin or polymer generally offer the greatest compromise of strength and flexibility. However, such belts must typically have a ratio of the bending diameter to the thickness of the load carrier of greater than 200 (that is, D/t>200, where “D” is bending diameter and “t” is load carrier thickness) to attain a sufficient fatigue life of the belt. For example, the minimum sheave diameter in a high rise elevator using known composite belts ranges from approximately 600 millimeters to approximately 1000 millimeters due to the stiffness of suitable resin casings. Typically, the resin must have a Young's modulus of approximately 2 gigapascals (GPa) or greater to adequately support the fibers or strands.

When a tension member is engaged with a sheave, the tension member is subjected to compression along an outer area in contact with the sheave and tension along an outer area away from the sheave. Frictional tractive force between the tension member and the pulley can impart additional compression to the outer surface of the tension member where the tension member is bent around the sheave. Many materials used to manufacture elevator tension members are significantly stronger in tension than compression. For example, carbon fiber, which is used in many composite belt designs, is typically only 20-70% as strong in compression as it is in tension. Additionally, carbon fiber and many other materials used in strands are brittle when subjected to compression. Therefore, tension members are typically more likely to fail, especially due to fatigue, as a result of internal compression experienced during the engagement with the sheave. Accordingly, the minimum bend radii of existing tension members is governed by internal compression loads due to bending.

### SUMMARY OF THE INVENTION

In view of the foregoing, there exists a need for composite elevator belts which reduce or neutralize internal tension and/or compression loads such that the bending radius of the tension member is reduced while maintaining a high breaking strength. Additionally, there exists a need for methods and apparatuses for forming such composite elevator belts.

Embodiments of the present disclosure are directed to a composite elevator belt for engaging a sheave. The composite elevator belt includes a load carrier having at least one load carrier strand extending substantially parallel to a longitudinal axis of the load carrier and a resin coating surrounding the at least one load carrier strand and defining a plurality of predetermined, deformable cavities within the resin coating adjacent the at least one strand. When the elevator belt is bent around the sheave, the elevator belt defines a neutral bending zone located within the elevator belt generally coincident with the longitudinal axis, a tension zone radially outward of the neutral bending zone, and a compression zone radially inward from the neutral bending zone.

Embodiments of the present disclosure are directed to a composite elevator belt for engaging a sheave. The composite elevator belt includes a load carrier having at least one load carrier strand, in particular a plurality of load carrier strands, extending substantially parallel to a longitudinal axis of the load carrier and a resin coating surrounding the at least one load carrier strand and defining a plurality of predetermined, deformable cavities within the resin coating adjacent the at least one strand. When the elevator belt is bent around the sheave, the elevator belt defines a neutral bending zone located within the elevator belt generally coincident with the longitudinal axis, a tension zone radially outward of the neutral bending zone, and a compression zone radially inward from the neutral bending zone. The plurality of load carrier strands are arranged such that a space free of load carrier strands is provided between the load carrier strands. The space forms a straight continuous channel which travels from a first terminal end of the load carrier to an opposite terminal end of the load carrier.

Embodiments of the present disclosure are directed to a composite elevator belt for engaging a sheave. The composite elevator belt includes a load carrier having at least one load carrier strand, in particular a plurality of load carrier strands, extending substantially parallel to a longitudinal axis of the load carrier and a resin coating surrounding the at least one load carrier strand and defining a plurality of predetermined, deformable cavities within the resin coating adjacent the at least one strand. A first plurality of teeth extend transversely across a top surface of the resin coating. The first plurality of teeth comprise a root portion associated with the resin coating and a tip portion. When the elevator belt is bent around the sheave, the elevator belt defines a neutral bending zone located within the elevator belt generally coincident with the longitudinal axis, a tension zone radially outward of the neutral bending zone, and a compression zone radially inward from the neutral bending zone.

Embodiments of the present disclosure are directed to a composite elevator belt for engaging a sheave. The composite elevator belt includes a load carrier having at least one load carrier strand, in particular a plurality of load carrier strands, extending substantially parallel to a longitudinal axis of the load carrier and a resin coating surrounding the at least one load carrier strand and defining a plurality of predetermined, deformable cavities within the resin coating adjacent the at least one strand. A first plurality of teeth extend transversely across a top surface of the resin coating. The first plurality of teeth comprise a root portion associated with the resin coating and a tip portion. When the elevator belt is bent around the sheave, the elevator belt defines a neutral bending zone located within the elevator belt generally coincident with the longitudinal axis, a tension zone radially outward of the neutral bending zone, and a compression zone radially inward from the neutral bending zone. The plurality of load carrier strands are arranged such that a space free of load carrier strands is provided between the load carrier strands. The space forms a straight continuous channel which travels from a first terminal end of the load carrier to an opposite terminal end of the load carrier.

A “terminal end” refers to an outermost surface of the load carrier. It can be located at any position on the load carrier body, for example at a top surface and a bottom surface of the core layer of the load carrier. An “opposite terminal end” refers to a terminal end which is not the first terminal end. The opposite terminal end can be located when, starting from the first terminal end, the straight continuous channel free of load carrier strands is followed until the straight continuous channel terminates at an outermost surface of the load carrier. This outermost surface can be parallel to the first terminal end or not parallel to the first terminal end.

A “straight continuous channel” refers to the space within the load carrier which is free from load carrier strands. The straight continuous channel may comprise a thermoset material; a thermoplastic material; any combination of thermoset and thermoplastic materials; a polymer material; a polymer matrix material; a silicon matrix material; a sizing material, e.g., adhesive; or a polymer material which is reinforced with non-load carrying fibers. A straight continuous channel can also be referred to as an “inter-strand space” or more simply a “space”. The space is defined by the distance between two adjacent load carrier strands. A first space can be the same size as a second space, or different.

In some embodiments, the inter-strand space is greater in the thickness direction than the inter-strand space in the width direction. The inter-strand space in the width direction is preferably between 0 μm and 5 μm. The inter-strand space in the thickness direction is preferably between 3 μm and 50 μm. Most preferably, the inter-strand space in the thickness direction is half of the carbon fiber diameter. Preferably, the distance the straight continuous channel covers or the straight continuous channels cover, is the same as the thickness and/or width of the load carrier. In the case of a rectangular load carrier, the space can cover an uninterrupted distance across either the thickness of the load carrier, or, across the width of the load carrier or across both the thickness and the width of the load carrier. In the case of an elliptical load carrier, the largest distance the space covers is defined by the length of a first diameter which runs between two peripheral end points of the load carrier, which are positioned the furthest away from each other.

In some embodiments, the composite elevator belt has a cross-section along the longitudinal axis which shows the plurality of predetermined, deformable cavities having symmetry about a first axis, or symmetry about a first axis and at least one further axis.

In some embodiments, there is a plurality of spaces free of load carrier strands provided throughout the load carrier. Each space forms a straight continuous channel which travels from a first terminal end of the load carrier to an opposite terminal end of the load carrier.

In some embodiments, the plurality of load carrier strands are arranged into a plurality of groups.

In some embodiments, each group is encased with a further material.

In some embodiments, the further material is selected from the group comprising a sizing material, a polymer material, a silicon material or a combination of any thereof.

In some embodiments, the space free of load carrier strands covers a distance of between 0 μm to 50 μm.

In some embodiments the load carrier strand has a diameter in the range of 2 μm to 20 μm, more preferably, in the range of from 5 μm to 15 μm, most preferably, in the range of from 6 μm to 10 μm.

In some embodiments where a plurality of spaces are present within the load carrier strand, each space can cover varying distances. For example, a composite belt comprising a load carrier comprising plurality of load carrier strands can have a space in the width direction of 0 μm and a space in the thickness direction of 10 μm; or a composite belt comprising a load carrier comprising a plurality of load carrier strands can have a first space in the width direction of 0 μm and a second space in the width direction of 1.5 μm, a first space in the thickness direction of 7 μm and a second space in the thickness direction of 20 μm. The distance of the space in the width direction can be one particular distance or a combination of various distances. The distance of the space in the thickness direction can be one particular distance or a combination of various distances. This can be adapted according to the flexibility requirements expected of the load carrier. Another example can be a composite belt comprising a load carrier comprising a plurality of load carrier strands having a space in the width direction of 0.5 μm and a space in the thickness direction of 3 μm. When at least two different sizes of inter-strand space are present within a load carrier, the larger of the two sizes is located in the width direction (i.e., laterally) or in the thickness direction (i.e., vertically).

In some embodiments, the plurality of load-carrier strands is arranged such that a higher strand density is located at a particular area. For example, a higher density of load-carrier strands can be located towards the center of the load-carrier, or located at the periphery of the load-carrier. Preferably, a higher strand density is located in the center of the load-carrier and a lower strand density is located at the periphery of the load-carrier. This arrangement allows for better flexibility of the load-carrier

In some embodiments the resin coating, which can also be referred to as a “core layer” or “matrix” comprises a material with a Young's modulus of less than 2 GPa. This is practicable in particular when teeth are included on the load carrier, and there is an advantageous arrangement of the load carrier strands. These combined features provide for a controlled buckling, which consequently allows for a material with a Young's modulus of 2 GPa or less, to be used as the resin coating.

In some embodiments the fiber volume ratio of the load carrier strands is in a range of from 40% to 70%.

In some embodiments the first plurality of teeth is reinforced with fibers. These can be any fibers as herein described, preferably the reinforcing fibers are smaller in length than the load carrier strands.

In some embodiments the first plurality of teeth is reinforced with fibers which are positioned in a transversal or criss-cross direction compared to the longitudinal direction of the load carrier strands.

In some embodiments the height of a tooth within the first plurality of teeth is in a range from 15 μm to 1 mm, preferably in a range from 200 μm to 600 μm.

The presence of teeth on a composite elevator belt affects the deflection, or buckling of the load carrier strands and consequently help reduce the compression force in the strands. When the fibers in a compression zone of the composite belt buckle, the neutral bending axes shifts in the direction of the tension zone and the overall stress in the belt decreases. Buckling can be activated by force or by a geometric imbalance. The introduction of teeth to the load carrier be it in a symmetrical or unsymmetrical pattern, helps introduce a force unbalance, which improves buckling and consequently reduces the compression forces in the load carrier strands. Teeth which are arranged in a symmetrical pattern on a load carrier allow the introduction of symmetrical repeatable buckling. Teeth which are arranged in an unsymmetrical pattern are preferred when issues such as vibration, noise or concentrated fiber fatigue arise. The teeth can be reinforced with fibers, either transversal, or in a criss-cross direction compared to the longitudinal unidirectional load carrier strands. The shape and dimensions of teeth are selected according to the strength and dimensions of the load carrier itself. Tooth shape can include rectangular, trapezoidal, triangular, rounded, among others.

The dimensions of the teeth, including, height, width and distance between each tooth, should be designed to take into consideration the possibility that some jacket material may enter the gap between the teeth. Should this happen, the height of the teeth for example is reduced. By taking this into consideration when designing the height of the teeth and by ensuring that the resultant tooth height, including the jacket layer, is a height which achieves the desired buckling effect, the reduction in compression forces in the load carrier strands can be optimized.

A preferred tooth height is between 40 microns and 1 mm. This applies to teeth used in a first plurality of teeth as well as to teeth used in a second or further plurality of teeth.

In some embodiments, when the elevator belt is bent around the sheave, the deformable cavities in the tension zone lengthen longitudinally relative to the longitudinal axis and retract radially relative to the longitudinal axis. When the elevator belt is bent around the sheave, the deformable cavities in the compression zone shorten longitudinally relative to the longitudinal axis and lengthen radially relative to the longitudinal axis.

In some embodiments, the load carrier includes a plurality of load carrier strands. The plurality of load carrier strands includes a first load carrier strand located in the tension zone and a second load carrier strand located in the compression zone.

In some embodiments, the first load carrier strand and the second load carrier strand each extend generally parallel to the longitudinal axis.

In some embodiments, when the elevator belt is bent around the sheave, the first load carrier strand is tensioned in a direction generally parallel to the longitudinal axis and the deformable cavities adjacent the first load carrier strand lengthen longitudinally in a direction generally parallel to the first load carrier strand and shorten radially in the direction generally perpendicular to the first load carrier strand to reposition the first load carrier strand radially closer to the neutral bending zone.

In some embodiments, when the elevator belt is bent around the sheave, the deformable cavities adjacent the second load carrier strand shorten longitudinally in a direction generally parallel to the first load carrier strand and lengthen radially in the direction generally perpendicular to the first load carrier strand inducing the second load carrier strand to deform into an undulating curve.

In some embodiments, when the elevator belt is bent around the sheave, the undulating curve of the second load carrier strand bends at least partially around the deformed cavities adjacent the second load carrier strand.

In some embodiments, the plurality of load carrier strands includes a third load carrier strand disposed between the first load carrier strand and the second load carrier strand and located in the neutral bending zone.

In some embodiments, each of the plurality of cavities encloses one of a gas, a liquid, and a deformable solid.

In some embodiments, a diameter of each of the plurality of cavities is between one-half and two times the diameter of the at least one load carrier strand.

In some embodiments, the at least one load carrier strand is non-continuous.

In some embodiments, the combined Young's modulus of the resin coating including the plurality of cavities is less than approximately 2 gigapascals.

In some embodiments, a total volume of the plurality of cavities in the compression zone is substantially equal to one third of a total volume of the resin coating, including the total volume of the plurality of cavities, in the compression zone.

In some embodiments, a total volume of the plurality of cavities in the tension zone is substantially equal to one third of a total volume of the resin coating, including the total volume of the plurality of cavities, in the tension zone.

In some embodiments, the composite elevator belt further includes a jacket layer disposed on the load carrier.

Still other embodiments of the present disclosure are directed to use of a composite elevator belt in an elevator system which includes an elevator shaft having a support frame, an elevator car movable along a vertical travel path defined by the elevator shaft, and a motor arrangement including at least one drive sheave rotatable via the motor arrangement.

Still other embodiments of the present disclosure are directed to methods of making a composite elevator belt for engaging a sheave. The method includes drawing a load carrier having at least one load carrier strand into a liquid resin bath, surrounding the at least one load carrier strand with a resin coating in the liquid resin bath, and defining a plurality of deformable cavities adjacent the at least one load carrier strand in the resin coating.

In some embodiments, the method further includes drawing the load carrier with the resin coating through a forming and curing die and curing the resin coating into a solidified form to define the plurality of deformable cavities in the resin coating.

In some embodiments, the method further includes depositing a jacket layer onto the resin coating after solidifying the resin coating into the solidified form.

In some embodiments, the method further includes intermixing an additive into the liquid resin bath, the additive being one of gas particles, liquid particles, and deformable solid particles. The plurality of deformable cavities are defined by the resin coating solidifying to surround the additive.

In some embodiments, a volume of the additive intermixed into the liquid resin bath is substantially equal to a volume of the liquid resin in the liquid resin bath.

In some embodiments, the method further includes intermixing a blowing agent into the liquid resin bath. Curing the resin coating causes the blowing agent to at least partially decompose into gas pockets in the liquid resin surrounding the load carrier strand. The plurality of deformable cavities are defined by the resin coating solidifying around the gas pockets.

In some embodiments, the method further includes drawing a second load carrier having at least one load carrier strand into a second liquid resin bath, surrounding the at least one load carrier strand of the second load carrier with a resin coating in the second liquid resin bath, and defining a plurality of deformable cavities adjacent the at least one load carrier strand of the second load carrier in the resin coating.

In some embodiments, the method further includes drawing the first load carrier with the resin coating having the plurality of deformable cavities formed therein into a forming and curing die, drawing the second load carrier with the resin coating having the plurality of deformable cavities formed therein into the forming and curing die, joining the first load carrier with the second load carrier together in the forming and curing die, and curing the resin coatings on the first load carrier and the second load carrier into solidified form in the forming and curing die.

In some embodiments, the method further includes drawing a third load carrier having at least one load carrier strand into a third liquid resin bath and surrounding the at least one load carrier strand of the third load carrier with a resin coating in the third liquid resin bath.

In some embodiments, the method further includes drawing the first load carrier with the resin coating having the plurality of deformable cavities formed therein into a forming and curing die, drawing the second load carrier with the resin coating having the plurality of deformable cavities formed therein into the forming and curing die, drawing the third load carrier with the resin coating into the forming and curing die interposed between the first load carrier and the second load carrier, joining the first load carrier with the second load carrier together with the third load carrier interposed between the first load carrier and the second load carrier in the forming and curing die, and curing the resin coatings on the first load carrier, the second load carrier, and the third load carrier into solidified form in the forming and curing die. Still other embodiments of the present disclosure are directed to methods of making a composite elevator belt for engaging a sheave. The method includes drawing a load carrier comprising at least one load carrier strand into a fiber arranger, followed by drawing the load carrier comprising at least one load carrier strand into a cavity printer to define a plurality of deformable cavities adjacent the at least one load carrier strand in the resin coating, curing the plurality of deformable cavities to produce a load carrier comprising a plurality of cured cavities, drawing the load carrier comprising a cured plurality of cavities into a liquid resin bath and surrounding the at least one load carrier strand with a resin coating in the liquid resin bath.

In some embodiments, the method further includes drawing the load carrier with the resin coating into a forming and curing die.

In some embodiments, the method further includes depositing a jacket layer onto the resin coating.

In some embodiments, the method further includes drawing a second load carrier comprising at least one load carrier strand into a fiber arranger, followed by drawing the second load carrier comprising at least one load carrier strand into a cavity printer to define a plurality of deformable cavities adjacent the at least one load carrier strand in the resin coating, curing the plurality of deformable cavities to produce a second load carrier comprising a plurality of cured cavities, drawing the second load carrier comprising a cured plurality of cavities into a second liquid resin bath and surrounding the at least one load carrier strand of the second load carrier with a resin coating in the second liquid resin bath.

In some embodiments, the method further includes drawing the first load carrier with the resin coating having the plurality of deformable cavities formed therein into a forming and curing die, drawing the second load carrier with the resin coating having the plurality of deformable cavities formed therein into the forming and curing die, joining the first load carrier with the second load carrier together in the forming and curing die, curing the resin coatings on the first load carrier and the second load carrier into solidified form in the forming and curing die.

In some embodiments, the method further includes drawing a third load carrier comprising at least one load carrier strand into a fiber arranger, followed by drawing the third load carrier comprising at least one load carrier strand into a cavity printer to define a plurality of deformable cavities adjacent the at least one load carrier strand in the resin coating, curing the plurality of deformable cavities to produce a third load carrier comprising a plurality of cured cavities, drawing the third load carrier comprising a cured plurality of cavities into a third liquid resin bath and surrounding the at least one load carrier strand of the third load carrier with a resin coating in the third liquid resin bath.

In some embodiments, the method further includes drawing the first load carrier with the resin coating having the plurality of deformable cavities formed therein into a forming and curing die, drawing the second load carrier with the resin coating having the plurality of deformable cavities formed therein into the forming and curing die, drawing the third load carrier with the resin coating into the forming and curing die interposed between the first load carrier and the second load carrier, joining the first load carrier with the second load carrier together with the third load carrier interposed between the first load carrier and the second load carrier in the forming and curing die, curing the resin coatings on the first load carrier, the second load carrier, and the third load carrier into solidified form in the forming and curing die

Still other embodiments of the present disclosure are directed to an elevator system including an elevator shaft having a support frame, an elevator car movable along a vertical travel path defined by the elevator shaft, a motor arrangement including at least one drive sheave rotatable via the motor arrangement, and at least one composite elevator belt in frictional tractive engagement with and configured to bend around the drive sheave of the motor arrangement. The at least one composite elevator belt includes a load carrier having at least one load carrier strand extending substantially parallel to a longitudinal axis of the load carrier and a resin coating surrounding the at least one load carrier strand and defining a plurality of predetermined, deformable cavities within the resin coating adjacent the at least one strand. When the elevator belt is bent around the drive sheave, the elevator belt defines a neutral bending zone located within the elevator belt generally coincident with the longitudinal axis, a tension zone radially outward of the neutral bending zone, and a compression zone radially inward from the neutral bending zone.

In some embodiments, when the elevator belt is bent around the drive sheave, the deformable cavities in the tension zone lengthen longitudinally relative to the longitudinal axis and retract radially relative to the longitudinal axis. When the elevator belt is bent around the drive sheave, the deformable cavities in the compression zone shorten longitudinally relative to the longitudinal axis and lengthen radially relative to the longitudinal axis.

In some embodiments, the load carrier of the composite elevator belt includes a plurality of load carrier strands. The plurality of load carrier strands includes a first load carrier strand located in the tension zone and a second load carrier strand located in the compression zone.

In some embodiments, each of the plurality of cavities of the at least one composite elevator belt encloses one of a gas, a liquid, and a deformable solid.

In some embodiments a diameter of each cavity in the at least one composite elevator belt is between one-half and two times a diameter of each load carrier strand in the at least on composite elevator belt.

Further embodiments of the present disclosure will now be described in the following numbered clauses:

Clause 1. A composite elevator belt for engaging a sheave, the composite elevator belt comprising: a load carrier comprising at least one load carrier strand extending substantially parallel to a longitudinal axis of the load carrier; and a resin coating surrounding the at least one load carrier strand and defining a plurality of predetermined, deformable cavities within the resin coating adjacent the at least one strand; wherein, when the elevator belt is bent around the sheave, the elevator belt defines a neutral bending zone located within the elevator belt generally coincident with the longitudinal axis, a tension zone radially outward of the neutral bending zone, and a compression zone radially inward from the neutral bending zone.

Clause 2. A composite elevator belt for engaging a sheave, the composite elevator belt comprising: a load carrier comprising at least one load carrier strand, in particular, a plurality of load carrier strands, extending substantially parallel to a longitudinal axis of the load carrier; and a resin coating surrounding the at least one load carrier strand and defining a plurality of predetermined, deformable cavities within the resin coating adjacent the at least one strand; wherein, when the elevator belt is bent around the sheave, the elevator belt defines a neutral bending zone located within the elevator belt generally coincident with the longitudinal axis, a tension zone radially outward of the neutral bending zone, and a compression zone radially inward from the neutral bending zone; wherein the plurality of load carrier strands are arranged such that a space free of load carrier strands is provided between the load carrier strands; wherein the space forms a straight continuous channel which travels from a first terminal end of the load carrier to an opposite terminal end of the load carrier.

Clause 3. A composite elevator belt for engaging a sheave, the composite elevator belt comprising: a load carrier comprising at least one load carrier strand, in particular, a plurality of load carrier strands, extending substantially parallel to a longitudinal axis of the load carrier; and a resin coating surrounding the at least one load carrier strand and defining a plurality of predetermined, deformable cavities within the resin coating adjacent the at least one strand; and a first plurality of teeth extending transversely across a top surface of the resin coating, the first plurality of teeth comprising a root portion associated with the resin coating and a tip portion wherein, when the elevator belt is bent around the sheave, the elevator belt defines a neutral bending zone located within the elevator belt generally coincident with the longitudinal axis, a tension zone radially outward of the neutral bending zone, and a compression zone radially inward from the neutral bending zone.

Clause 4. A composite elevator belt for engaging a sheave, the composite elevator belt comprising: a load carrier comprising at least one load carrier strand, in particular, a plurality of load carrier strands, extending substantially parallel to a longitudinal axis of the load carrier; and a resin coating surrounding the at least one load carrier strand and defining a plurality of predetermined, deformable cavities within the resin coating adjacent the at least one strand; and a first plurality of teeth extending transversely across a top surface of the resin coating, the first plurality of teeth comprising a root portion associated with the resin coating and a tip portion; wherein, when the elevator belt is bent around the sheave, the elevator belt defines a neutral bending zone located within the elevator belt generally coincident with the longitudinal axis, a tension zone radially outward of the neutral bending zone, and a compression zone radially inward from the neutral bending zone; wherein the plurality of load carrier strands are arranged such that a space free of load carrier strands is provided between the load carrier strands; wherein the space forms a straight continuous channel which travels from a first terminal end of the load carrier to an opposite terminal end of the load carrier.

Clause 5. The composite elevator belt of any of clauses 1 to 4, wherein a cross-section of the elevator belt along the longitudinal axis shows the plurality of predetermined, deformable cavities having: a) symmetry about a first axis (A); or b) symmetry about a first axis A (A) and at least one further axis (B). Preferably, the plurality of cavities are arranged so that the cavities in the tension zone are a mirror inversion of the cavities in the compression zone, or the plurality of cavities in the compression zone and the plurality of cavities the tension zone are symmetrical.

Clause 6. The composite elevator belt of any of clauses 2, 4 to 5, wherein a plurality of spaces free of load carrier strands is provided throughout the load carrier and wherein each space forms a straight continuous channel which travels from a first terminal end of the load carrier to an opposite terminal end of the load carrier.

Clause 7. The composite elevator belt of any of clauses 2 to 6, wherein the plurality of load carrier strands are arranged into a plurality of groups.

Clause 8. The composite elevator belt of clause 7, wherein each group is encased with a further material.

Clause 9. The composite elevator belt of clause 8, wherein the further material is selected from the group comprising: a sizing material, a polymer material, a silicon material, or a combination of any thereof.

Clause 10. The composite elevator belt of any of clauses 2, 4 to 9, wherein the space covers a distance of between 0 μm to 50 μm

Clause 11. The composite elevator belt of any of clauses 1 to 10, wherein the load carrier strand has a diameter in the range of 2 μm to 20 μm.

Clause 12. The composite elevator belt of any of clauses 2, 4 to 11, wherein the space can be adapted to cover varying distances throughout the cross-section of the load carrier.

Clause 13. The composite elevator belt of any of clauses 1 to 12, wherein, when the elevator belt is bent around the sheave, the deformable cavities in the tension zone lengthen longitudinally relative to the longitudinal axis and retract radially relative to the longitudinal axis, and wherein, when the elevator belt is bent around the sheave, the deformable cavities in the compression zone shorten longitudinally relative to the longitudinal axis and lengthen radially relative to the longitudinal axis.

Clause 14. The composite elevator belt of any of clauses 1 to 13, wherein the load carrier comprises a plurality of load carrier strands, the plurality of load carrier strands comprising a first load carrier strand located in the tension zone and a second load carrier strand located in the compression zone.

Clause 15. The composite elevator belt of any of clauses 1 to 14, wherein the first load carrier strand and the second load carrier strand each extend generally parallel to the longitudinal axis.

Clause 16. The composite elevator belt of any of clauses 1 to 15, wherein, when the elevator belt is bent around the sheave, the first load carrier strand is tensioned in a direction generally parallel to the longitudinal axis and the deformable cavities adjacent the first load carrier strand lengthen longitudinally in a direction generally parallel to the first load carrier strand and shorten radially in the direction generally perpendicular to the first load carrier strand to reposition the first load carrier strand radially closer to the neutral bending zone.

Clause 17. The composite elevator belt of any of clauses 1 to 16, wherein, when the elevator belt is bent around the sheave, the deformable cavities adjacent the second load carrier strand shorten longitudinally in a direction generally parallel to the first load carrier strand and lengthen radially in the direction generally perpendicular to the first load carrier strand inducing the second load carrier strand to deform into an undulating curve.

Clause 18. The composite elevator belt of any of clauses 1 to 17, wherein, when the elevator belt is bent around the sheave, the undulating curve of the second load carrier strand bends at least partially around the deformed cavities adjacent the second load carrier strand.

Clause 19. The composite elevator belt of any of clauses 1 to 18, wherein the plurality of load carrier strands comprises a third load carrier strand disposed between the first load carrier strand and the second load carrier strand and located in the neutral bending zone.

Clause 20. The composite elevator belt of any of clauses 1 to 19, wherein each of the plurality of cavities encloses one of a gas, a liquid, and a deformable solid. The cavity material can for example be a silicon material with a young's modulus of less than 0.1 GPA, or a curable viscosity gel-like silicon material with a high viscosity. The cavity material preferably has a good impregnation behavior in the uncured state, this is beneficial for the production process. Curing can be activated for example by heat, an electronic beam or UV light.

Clause 21. The composite elevator belt of any of clauses 1 to 20, wherein a diameter of each of the plurality of cavities is between one-half and two times the diameter of the at least one load carrier strand.

Clause 22. The composite elevator belt of any of clauses 1 to 21, wherein the at least one load carrier strand is non-continuous.

Clause 23. The composite elevator belt of any of clauses 1 to 22, wherein the combined Young's modulus of the resin coating including the plurality of cavities is less than approximately 2 gigapascals.

Clause 24. The composite elevator belt of any of clauses 1 to 23, wherein a total volume of the plurality of cavities in the compression zone is substantially equal to one third of a total volume of the resin coating, including the total volume of the plurality of cavities, in the compression zone. Preferably, the matrix volume:fiber volume ratio is the same for the compression and tension zone. This is advantageous because if counter bending occurs, the tension zone can become the compression zone and vice versa. The fiber volume content in the neutral zone can be different, preferably higher than that in the tension and compression zones.

Clause 25. The composite elevator belt of any of clauses 1 to 24, further comprising a jacket layer disposed on the load carrier. The composite elevator belt can also comprises a first jacket layer extending in the longitudinal direction, wherein, when the load carrier comprises a first plurality of teeth comprising a root portion and a tip portion, the tip portion is associated with a bottom surface of the further jacket layer. It is also envisaged that the elevator belt can further comprise a second plurality of teeth comprising a root portion and a tip portion, wherein the tip portion is associated with a bottom surface of a second further jacket layer.

Clause 26. Use of the composite elevator belt of any of clauses 1 to 25 in an elevator system, the elevator system comprising: an elevator shaft having a support frame; an elevator car movable along a vertical travel path defined by the elevator shaft; and a motor arrangement comprising at least one drive sheave rotatable via the motor arrangement.

Clause 27. A method of making a composite elevator belt for engaging a sheave, the method comprising: drawing a load carrier comprising at least one load carrier strand into a liquid resin bath; surrounding the at least one load carrier strand with a resin coating in the liquid resin bath; and defining a plurality of deformable cavities adjacent the at least one load carrier strand in the resin coating.

Clause 28. The method of clause 27, further comprising: drawing the load carrier with the resin coating into a forming and curing die; and curing the resin coating into a solidified form to define the plurality of deformable cavities in the resin coating. Preferably the curing mode is different for the cavity material and the resin coating, this prevents instable boundary layers between the resin coating and cavities. Instable boundary layers could cause cracks or unwanted voids in the resin coating

Clause 29. The method of clause 27 or 28, further comprising depositing a jacket layer onto the resin coating after solidifying the resin coating into the solidified form.

Clause 30. The method of any of clauses 27 to 29, further comprising intermixing an additive into the liquid resin bath, wherein the additive comprises one of gas particles, liquid particles, and deformable solid particles, and wherein the plurality of deformable cavities are defined by the resin coating solidifying around the additive.

Clause 31. The method of any of clauses 27 to 30, wherein a volume of the additive intermixed into the liquid resin bath is substantially equal to a volume of the liquid resin in the liquid resin bath.

Clause 32. The method of any of clauses 27 to 31, further comprising intermixing a blowing agent into the liquid resin bath, wherein curing the resin coating causes the blowing agent to at least partially decompose into gas pockets in the liquid resin surrounding the load carrier strand, and wherein the plurality of deformable cavities are defined by the resin coating solidifying around the gas pockets.

Clause 33. The method of any of clauses 27 to 32, further comprising: drawing a second load carrier comprising at least one load carrier strand into a second liquid resin bath; surrounding the at least one load carrier strand of the second load carrier with a resin coating in the second liquid resin bath; and defining a plurality of deformable cavities adjacent the at least one load carrier strand of the second load carrier in the resin coating.

Clause 34. The method of any of clauses 27 to 33, further comprising: drawing the first load carrier with the resin coating having the plurality of deformable cavities formed therein into a forming and curing die; drawing the second load carrier with the resin coating having the plurality of deformable cavities formed therein into the forming and curing die; joining the first load carrier with the second load carrier together in the forming and curing die; and curing the resin coatings on the first load carrier and the second load carrier into solidified form in the forming and curing die.

Clause 35. The method of any of clauses 27 to 34, further comprising: drawing a third load carrier comprising at least one load carrier strand into a third liquid resin bath; and surrounding the at least one load carrier strand of the third load carrier with a resin coating in the third liquid resin bath.

Clause 36. The method of any of clauses 27 to 35, further comprising: drawing the first load carrier with the resin coating having the plurality of deformable cavities formed therein into a forming and curing die; drawing the second load carrier with the resin coating having the plurality of deformable cavities formed therein into the forming and curing die; drawing the third load carrier with the resin coating into the forming and curing die interposed between the first load carrier and the second load carrier; joining the first load carrier with the second load carrier together with the third load carrier interposed between the first load carrier and the second load carrier in the forming and curing die; and curing the resin coatings on the first load carrier, the second load carrier, and the third load carrier into solidified form in the forming and curing die.

Clause 37. A method of making a composite elevator belt for engaging a sheave, the method comprising: drawing a load carrier comprising at least one load carrier strand into a fiber arranger; drawing the load carrier comprising at least one load carrier strand into a cavity printer to define a plurality of deformable cavities adjacent the at least one load carrier strand in the resin coating; curing the plurality of deformable cavities to produce a load carrier comprising a plurality of cured cavities; drawing the load carrier comprising a cured plurality of cavities into a liquid resin bath; surrounding the at least one load carrier strand with a resin coating in the liquid resin bath.

Clause 38. The method according to clause 37 further comprising: drawing the load carrier with the resin coating into a forming and curing die.

Clause 39. The method according to any of clauses 37 to 38 further comprising: depositing a jacket layer onto the resin coating.

Clause 40. The method according to any of clauses 37 to 39 further comprising: drawing a second load carrier comprising at least one load carrier strand into a fiber arranger; followed by drawing the second load carrier comprising at least one load carrier strand into a cavity printer to define a plurality of deformable cavities adjacent the at least one load carrier strand in the resin coating; curing the plurality of deformable cavities to produce a second load carrier comprising a plurality of cured cavities; drawing the second load carrier comprising a cured plurality of cavities into a second liquid resin bath and surrounding the at least one load carrier strand of the second load carrier with a resin coating in the second liquid resin bath.

Clause 41. The method according to any of clauses 37 to 40 further comprising: drawing the first load carrier with the resin coating having the plurality of deformable cavities formed therein into a forming and curing die; drawing the second load carrier with the resin coating having the plurality of deformable cavities formed therein into the forming and curing die; joining the first load carrier with the second load carrier together in the forming and curing die; curing the resin coatings on the first load carrier and the second load carrier into solidified form in the forming and curing die.

Clause 42. The method according to any of clauses 37 to 41 further comprising: drawing a third load carrier comprising at least one load carrier strand into a fiber arranger; followed by drawing the third load carrier comprising at least one load carrier strand into a cavity printer to define a plurality of deformable cavities adjacent the at least one load carrier strand in the resin coating; curing the plurality of deformable cavities to produce a third load carrier comprising a plurality of cured cavities; drawing the third load carrier comprising a cured plurality of cavities into a third liquid resin bath and surrounding the at least one load carrier strand of the third load carrier with a resin coating in the third liquid resin bath.

Clause 43. The method according to any of clauses 37 to 42 further comprising: drawing the first load carrier with the resin coating having the plurality of deformable cavities formed therein into a forming and curing die; drawing the second load carrier with the resin coating having the plurality of deformable cavities formed therein into the forming and curing die; drawing the third load carrier with the resin coating into the forming and curing die interposed between the first load carrier and the second load carrier; joining the first load carrier with the second load carrier together with the third load carrier interposed between the first load carrier and the second load carrier in the forming and curing die; curing the resin coatings on the first load carrier, the second load carrier, and the third load carrier into solidified form in the forming and curing die

Clause 44. An elevator system, comprising: an elevator shaft having a support frame; an elevator car movable along a vertical travel path defined by the elevator shaft; a motor arrangement comprising at least one drive sheave rotatable via the motor arrangement; and at least one composite elevator belt in frictional tractive engagement with and configured to bend around the drive sheave of the motor arrangement, the at least one composite elevator belt comprising: a load carrier comprising at least one load carrier strand extending substantially parallel to a longitudinal axis of the load carrier; and a resin coating surrounding the at least one load carrier strand and defining a plurality of predetermined, deformable cavities within the resin coating adjacent the at least one strand; wherein, when the elevator belt is bent around the drive sheave, the elevator belt defines a neutral bending zone located within the elevator belt generally coincident with the longitudinal axis, a tension zone radially outward of the neutral bending zone, and a compression zone radially inward from the neutral bending zone.

Clause 45. The elevator system of clause 44, wherein, when the elevator belt is bent around any of the drive sheaves or elevator, sheaves, the deformable cavities in the tension zone lengthen longitudinally relative to the longitudinal axis and retract radially relative to the longitudinal axis, and wherein, when the elevator belt is bent around the drive sheave, the deformable cavities in the compression zone shorten longitudinally relative to the longitudinal axis and lengthen radially relative to the longitudinal axis.

Clause 46. The elevator system of clause 44 or 45, wherein the load carrier of the composite elevator belt comprises a plurality of load carrier strands, and wherein the plurality of load carrier strands comprises a first load carrier strand located in the tension zone and a second load carrier strand located in the compression zone.

Clause 47. The elevator system of any of causes 44 to 46, wherein each of the plurality of cavities of the at least one composite elevator belt encloses one of a gas, a liquid, and a deformable solid.

Clause 48. The elevator system of any of clauses 44 to 47, wherein a diameter of each cavity in the at least one composite elevator belt is between one-half and two times a diameter of each load carrier strand in the at least on composite elevator belt.

These and other features and characteristics of composite elevator belts, methods of making the same, and use of the same in an elevator system will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and claims, the singular forms of “a”, “an”, and “the” include plural referents unless the context clearly dictates otherwise.

### BRIEF DESCRIPTION OF THE DRAWINGS

FIG. 1 is a side view of a typical tension member bent about an axis;

FIG. 2 is a transverse cross-section view through the typical tension member of FIG. 1;

FIG. 3A is a transverse cross-section view of a composite elevator belt according to an embodiment of the present disclosure;

FIGS. 3B-3D are transverse cross-section views of composite elevator belts according to other embodiments of the present disclosure;

FIG. 4 is a schematic view of a cross-section of the load carrier of the composite elevator belt of FIG. 3A in an unloaded state;

FIG. 5 is a schematic view of the cross-section of the load carrier of the composite elevator belt of FIG. 4 showing a representation of the deformation experienced by the composite elevator belt in a loaded state during use;

FIG. 6A is a schematic view showing a section of the load carrier of the composite elevator belt of FIG. 4 in a tension zone, prior to bending the composite elevator belt around a sheave;

FIG. 6B is the schematic view of FIG. 6A illustrating when the composite elevator belt is bent around a sheave;

FIG. 7A is a schematic view showing a section of the load carrier of the composite elevator belt of FIG. 4 in a compression zone, prior to bending the composite elevator belt around a sheave;

FIG. 7B is the schematic view of FIG. 7A illustrating when the composite elevator belt is bent around a sheave;

FIG. 8 is a perspective view of the section of FIG. 7B;

FIG. 9 is a perspective view of an elevator system utilizing a composite elevator belt according to the present disclosure; and

FIG. 10 illustrates a manufacturing apparatus for making a composite elevator belt according to an embodiment of the present disclosure.

FIGS. 11A to 11C show transverse cross-section views of a composite elevator belt according to an embodiment of the present disclosure;

FIGS. 12A to 12C. show transverse cross-section views of a composite elevator belt according to an embodiment of the present disclosure;

FIGS. 13A to 13C show transverse cross-section views of a composite elevator belt according to an embodiment of the present disclosure;

FIGS. 14A to 14C show transverse cross-section views of a composite elevator belt according to an embodiment of the present disclosure;

FIGS. 15A to 15C show transverse cross-section views of a load carrier within a composite elevator belt according to an embodiment of the present disclosure;

FIGS. 16A to 16C show transverse cross-section views of a load carrier within a composite elevator belt according to an embodiment of the present disclosure;

FIGS. 17A and 17B show transverse cross-section views of a load carrier within a composite elevator belt according to an embodiment of the present disclosure;

FIG. 18 shows both a transverse and longitudinal cross-section view of a load carrier within a composite elevator belt according to an embodiment of the present disclosure;

FIG. 19 shows both a transverse and longitudinal cross-section view of a load carrier within a composite elevator belt according to an embodiment of the present disclosure;

FIGS. 20A and 20B show a longitudinal cross-section view of a composite elevator belt according to an embodiment of the present disclosure.

FIG. 21 shows a transverse cross-section view of a load carrier within a composite elevator belt according to an embodiment of the present disclosure;

FIG. 22 illustrates a manufacturing apparatus for making a composite elevator belt according to an embodiment of the present disclosure.

FIG. 23 illustrates a manufacturing apparatus for making a composite elevator belt according to an embodiment of the present disclosure.

FIG. 24 illustrates a manufacturing apparatus for making a composite elevator belt according to an embodiment of the present disclosure.

### DETAILED DESCRIPTION OF THE INVENTION

For purposes of the description hereinafter, the terms “upper”, “lower”, “right”, “left”, “vertical”, “horizontal”, “top”, “bottom”, “lateral”, “longitudinal”, and derivatives thereof shall relate to the disclosed apparatus as it is oriented in the figures. However, it is to be understood that the apparatus of the present disclosure may assume alternative variations and step sequences, except where expressly specified to the contrary. It is also to be understood that the specific systems and processes illustrated in the attached drawings and described in the following specification are simply exemplary examples of the apparatus disclosed herein. Hence, specific dimensions and other physical characteristics related to the examples disclosed herein are not to be considered as limiting.

As used herein, the terms “sheave” and “pulley” are used interchangeably to describe a wheel for tractive connection to a tension member of any type. It is to be understood that a “pulley” is encompassed by the recitation of a “sheave”, and vice versa, unless explicitly stated to the contrary.

As used herein, the terms “substantially” or “approximately”, when used to relate a first numerical value or condition to a second numerical value or condition, means that the first numerical value or condition is within 10 units or within 10% of the second numerical value or condition, as the context dictates and unless explicitly indicated to the contrary. For example, the term “substantially parallel to” means within plus or minus 10° of parallel. Similarly, the term “substantially perpendicular to” means within plus or minus 10° of perpendicular. Similarly, the term “substantially equal in volume” means within 10% of being equal in volume.

As used herein, the terms “transverse”, “transverse to”, and “transversely to” a given direction mean not parallel to that given direction. Thus, the terms “transverse”, “transverse to”, and “transversely to” a given direction encompass directions perpendicular to, substantially perpendicular to, and otherwise not parallel to the given direction.

As used herein, the term “diameter” means any straight line segment passing through a center point of a circle, sphere, ellipse, ellipsoid, or other rounded two- or three-dimensional object from one point on the periphery of said object to another point on the periphery of said object. Non-circular and non-spherical objects may have several such diameters of differing length, including a major diameter being the longest straight line segment meeting the aforementioned criteria, and a minor diameter being the shortest straight line segment meeting the aforementioned criteria.

As used herein, the term “associated with”, when used in reference to multiple features or structures, means that the multiple features or structures are in contact with, touching, directly connected to, indirectly connected to, adhered to, or integrally formed with one another.

Referring to the drawings in which like reference numerals refer to like parts throughout the several views thereof, the present disclosure is generally directed to a composite elevator belt for use in an elevator system to raise and lower an elevator car. It is to be understood, however, that the composite belt described herein may be used in many different applications in which tension members are utilized in traction with sheaves. The present disclosure is also directed to an elevator system utilizing the composite elevator belt. Further, the present disclosure is directed to methods of making the composite elevator belt.

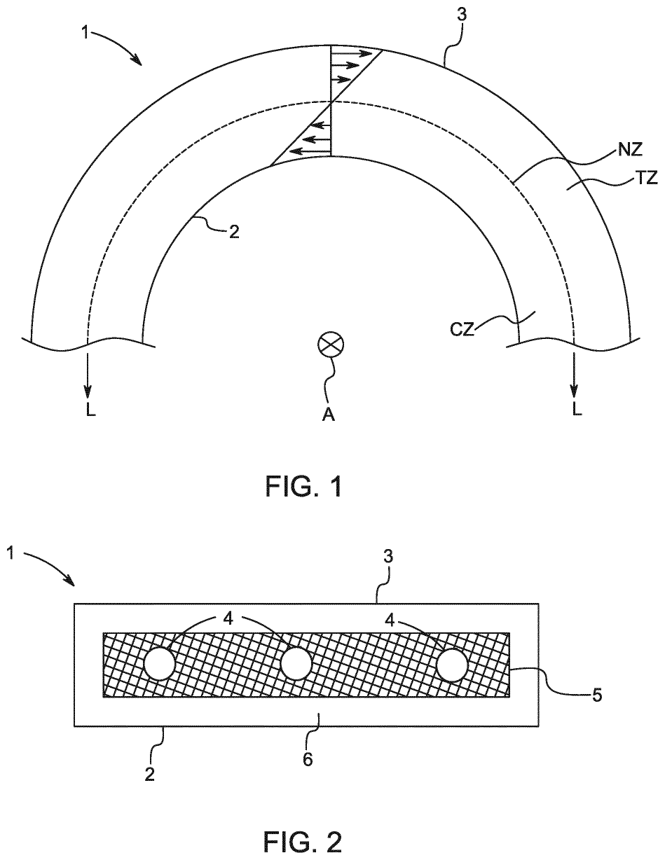

FIG. 1 illustrates a portion of a typical tension member 1 bent about an axis A, such as a sheave axis, perpendicular to the longitudinal axis L of the tension member. The tension member 1 has a centrally located longitudinal axis L, an inner surface 2 parallel to the longitudinal axis L and radially closest to the axis A, and an outer surface 3 parallel to the longitudinal axis L and radially farthest from the axis A. Generally coincident with the longitudinal axis L is a neutral bending zone NZ. With the tension member 1 bent about the axis A, the tension member 1 deforms such that the outer surface 3, which is radially farthest from the axis A, has a greater arc length than the inner surface 2, which is radially closest to the axis A. As a result of this deformation of the tension member 1, the portion of the tension member 1 between the inner surface 2 and the neutral bending zone NZ compresses, defining a compression zone CZ, and the portion of the tension member 1 between the outer surface 3 and the neutral bending zone NZ stretches, defining a tension zone TZ. The neutral bending zone NZ experiences zero or a negligible stress due to bending the tension member 1 about the axis A. The portion of the tension member 1 defining the compression zone CZ is subject to the compressive stress due to bending, ranging from zero or a negligible compressive stress adjacent the neutral bending zone NZ to a maximum compressive stress at the inner surface 2. Conversely, the portion of the tension member 1 defining the tension zone TZ is subject to the tensile stress due to bending, ranging from zero or a negligible tensile stress adjacent the neutral bending zone NZ to a maximum tensile stress at the outer surface 3. As shown by the arrows in FIG. 1, the compressive stress experienced by the tension member 1 in the compression zone CZ increases substantially linearly from the neutral bending zone NZ to the inner surface 2, and the tensile stress experienced by the tension member 1 in the tension zone TZ increases substantially linearly from the neutral bending zone NZ to the outer surface 3. If the compressive stress experienced in the compression zone CZ reach a critical threshold, the materials of the tension member 1 may experience buckling failure, especially if the materials are brittle. Even below this critical threshold of compressive stress, cyclical compression loading of the tension member 1 may result in fatigue failure.

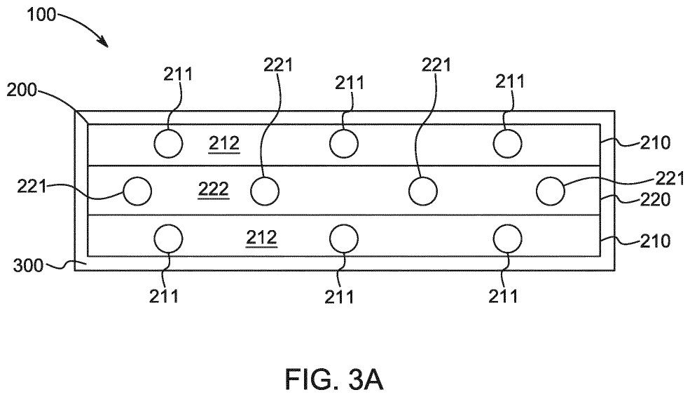

FIG. 2 illustrates a transverse cross-section view of the typical tension 1 member of FIG. 1. The tension member 1 generally includes one or more load carrying fibers 4 extending generally parallel to the length of the tension member 1 and encased in a matrix 5. The fibers 4 provide the tensile strength of the tension member 1. The fibers 4 and the matrix 5 may be encased in a jacket 6 adapted to tractively engage the sheave and protect both the sheave and fibers 4 from galling and other wear.

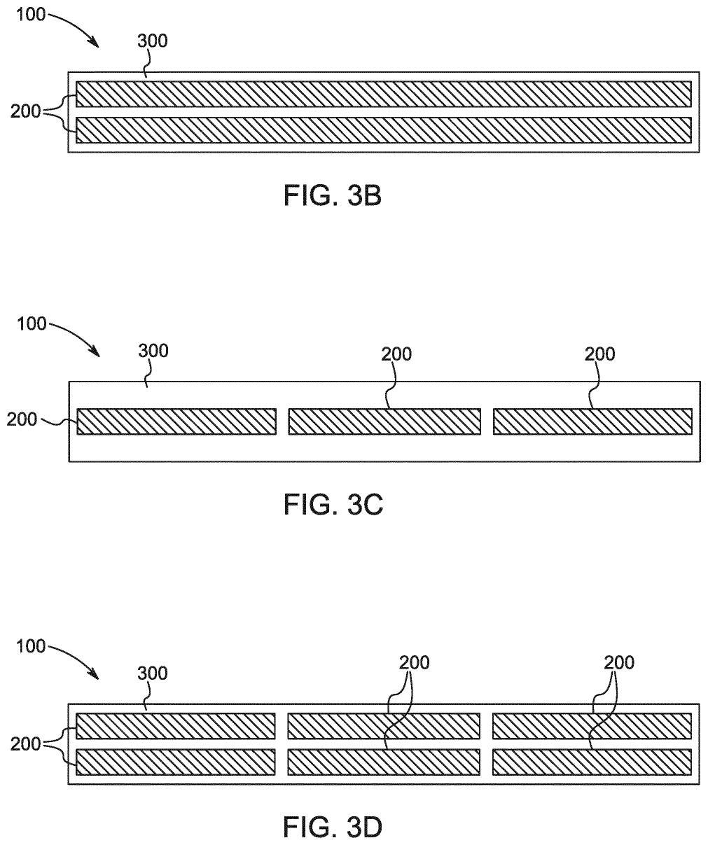

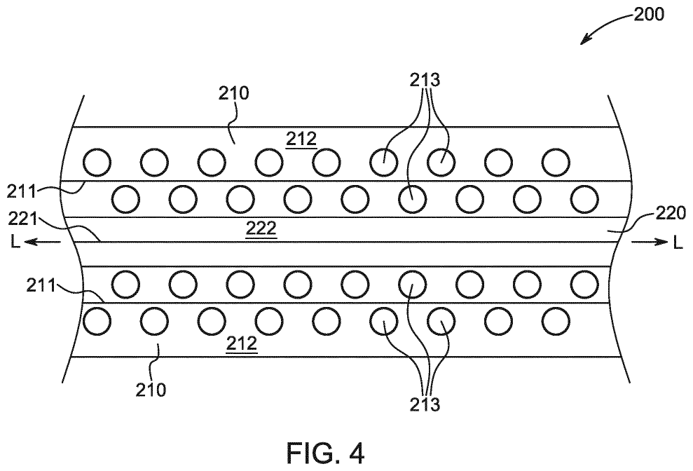

Referring now to FIGS. 3A-4, a tension member according to one embodiment of the present disclosure is a composite elevator belt 100 including a load carrier 200. In some embodiments, the load carrier 200 is encased in a jacket layer 300. The load carrier 200 provides the tensile strength of the composite elevator belt 100, while the jacket layer 300 is configured for tractive, frictional engagement with a running surface of a sheave, such as an idler sheave or drive sheave. As shown in FIGS. 3A and 4, the composite elevator belt 100 may include a single load carrier 200. However, other embodiments of the composite elevator belt 100, as shown in FIGS. 3B-3D, may include multiple load carriers 200 arranged in any configuration of rows and columns within the jacket layer 300.

Each load carrier 200 includes at least one outer layer 210 disposed on a central layer 220. Each of the at least one outer layers 210 may include one or more load carrier strands 211 arranged parallel to the longitudinal axis L of the composite elevator belt 100. In other embodiments, the load carrier strands 211 may be interrupted along the longitudinal axis L, and may or may not overlap one another. In still other embodiments, the load carrier strands 211 may be arranged in multiple layers spaced apart from one another in a direction perpendicular to the longitudinal axis L. In still other embodiments, the load carrier strands 211 may be entangled, discontinuous fibers arranged in a mat or roving. The load carrier strands 211 may be encased in a resin coating 212 which defines a cross-sectional profile of the outer layer 210 and fills any voids between the load carrier strands 211. The one or more load carrier strands 211 may account for between approximately 30% and approximately 60% of the total volume of each outer layer 210. However, the volume ratio of the load carrier strands 211 to the total volume of each outer layer 210 may be adjusted to balance the strength and flexibility of the composite elevator belt 100 for a particular application. Generally, increasing the volume ratio of the load carrier strands 211 to the total volume of each outer layer 210 increases the strength and decreases the flexibility of the composite elevator belt 100, while decreasing the volume ratio of the load carrier strands 211 to the total volume of each outer layer 210 decreases the strength and increases the flexibility of the composite elevator belt 100.

The central layer 220 may include one or more load carrier strands 221 arranged parallel to and continuous along the longitudinal axis L of the composite elevator belt 100. In other embodiments, the load carrier strands 221 may be interrupted along the longitudinal axis L, and may or may not overlap one another. In still other embodiments, the load carrier strands 221 may be arranged in multiple layers spaced apart from one another in a direction perpendicular to the longitudinal axis L. In still other embodiments, the load carrier strands 221 may be entangled, discontinuous fibers arranged in a mat or roving. The one or more load carrier strands 221 may be encased in a resin coating 222, which defines a cross-sectional profile of the central layer 220 and fills any voids between the load carrier strands 221. The resin coating 222 may be substantially free of any voids or impurities except for those unintentionally introduced during the manufacturing of the central layer 220. The one or more load carrier strands 221 may account for between approximately 60% and approximately 80% of the total volume of the central layer 220. However, the volume ratio of the load carrier strands 221 to the total volume of the central layer 220 may be adjusted to balance the strength and flexibility of the composite elevator belt 100 for a particular application. Generally, increasing the volume ratio of the load carrier strands 221 to the total volume of the central layer 220 increases the strength and decreases the flexibility of the composite elevator belt 100, while decreasing the volume ratio of the load carrier strands 221 to the total volume of the central layer 220 decreases the strength and increases the flexibility of the composite elevator belt 100.

As the at least one outer layer 210 may occupy either the compression zone CZ or the tension zone TZ of the composite elevator belt 100, the at least one outer layer 210 may be subject to greater loads due to bending than the central layer 220, which may be generally coincident with the neutral bending zone NZ. As such, the ratio of the volume of the load carrier strands 211 of each outer layer 210 to the total volume of that outer layer 210 may be less than the ratio of the volume of the load carrier strands 221 of the central layer 220 to the total volume of the central layer 220.

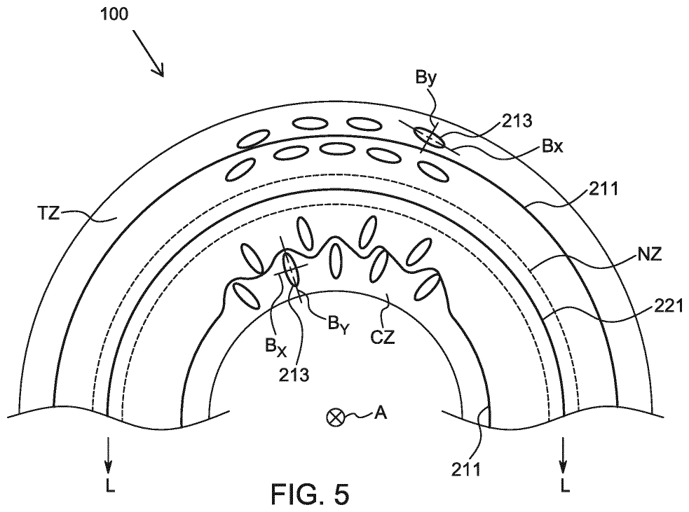

The resin coating 212 of each outer layer 210 defines a plurality of deformable cavities 213 interspersed throughout. The plurality of deformable cavities 213 are positioned adjacent to the load carrier strands 211, meaning each of the cavities 213 is spaced apart from the load carrier strands 211, in any direction from the longitudinal axis L, within the resin coating 212. Each of the plurality of cavities 213 encloses a material, which may be a solid, a liquid, or a gas, having a greater deformability than the deformability of the surrounding resin coating 212. The plurality of cavities 213 may account for approximately one third of the total volume of the resin coating 212, although the ratio of the volume of the cavities 213 to the total volume of the resin coating 212 may be adjusted to attain various levels of stress reduction in the composite elevator belt 100, as will be described in detail below with reference to FIG. 5. Each of the plurality of cavities 213 is generally spherical, ovoidal, or ellipsoidal in shape, having a first axis B_{X} parallel to the longitudinal axis L of the composite elevator belt 100 and a second axis B_{Y} radially perpendicular to the longitudinal axis L of the composite elevator belt 100. The cavities 213 are not limited to round shapes, and polygonal shapes of the cavities 213 are also considered. Further, the shape of the cavities 213 may be dictated by the method of production of the resin coating 212, as will be described in greater detail below. Additionally, the exact spacing and location of each deformable cavity 213 within the resin coating 212 may be a product of inherent variability in the manufacturing process during which the cavities 213 are defined. However, many properties of the cavities 213 may be predetermined despite variabilities in the manufacturing process. For example, the size of the cavities 213 and the ratio of the total volume of the cavities 213 per unit volume of the resin coating 212 may be predetermined and controlled throughout the manufacturing process. As such, the plurality of deformable cavities 213 may be differentiated from unintentionally occurring voids and/or discontinuities that would naturally occur in the resin coating 212. For this reason, the plurality of cavities 213 may be referred to as being predetermined or predefined.

As shown in FIGS. 5-8, each of the plurality of cavities 213 in the at least one outer layer 210 is configured to deform when the composite elevator belt 100 is bent about an axis A perpendicular to the longitudinal axis L of the composite elevator belt 100. As the composite elevator belt 100 bends around the axis A, the tension zone TZ of the composite elevator belt 100 lengthens relative to the compression zone CZ, causing the cavities 213 in the tension zone TZ and the compression zone CZ to deform in different orientations. In FIG. 5, the plurality of cavities 213 are shown in exaggerated size to more clearly indicate the deformation of the cavities 213.

Each cavity 213 in the compression zone CZ of the composite elevator belt 100 deforms by retracting or shortening along its first axis B_{X} and lengthening or extending along its second axis B_{Y}. Deformation of the cavities 213 reduces or neutralizes the compression loads experienced by the load carrier strands 211 in the compression zone CZ by allowing the load carrier strands 211 to reposition within the outer layer 210 to a state of reduced stress. The lengthening of each cavity 213 along its second axis B_{Y} exerts a normal force F_{N} on the load carrier strands 211 in a radial direction perpendicular to the longitudinal axis L. The normal forces F_{N} exerted by the cavities 213 on opposite sides of the load carrier strands 211 counteract or neutralize the compressive stress experienced by the load carrier strands 211 due to bending the composite elevator belt 100 about the axis A. More specifically, the normal forces F_{N} exerted by the cavities 213 induce the load carrier strands 211 into an undulating curve bending at least partially around the deformed cavities 213. Because an undulating curve inherently has a greater length than a similarly situated smooth curve, inducing the load carrier strands 211 into the undulating curve increases the length of each load carrier strand 211 in the compression zone CZ. The load carrier strands 211 may stretch to attain the increased length of the undulating curve in the compression zone CZ, thus subjecting the load carrier strands 211 to tensile stress which counteracts, and preferably exceeds, the compressive stress due to bending about the axis A. Reduction or elimination of the of the compressive stress on the load carrier strands 211 in the compression zone CZ allows the composite elevator belt 100 to attain a tighter bend radius without exceeding the maximum allowable internal compression. Additionally, replacement of the compressive stress in the load carrier strands 211 with tensile stress eliminates the risk of localized buckling failure and, as the materials used in the load carrier strands 211 are generally much stronger in tension than compression, the load carrier strands 211 may be expected to exhibit a longer service and fatigue life.

In contrast to the cavities 213 in the compression zone CZ, the cavities 213 in the tension zone TZ deform by lengthening or extending along their first axes B_{X} and retracting or shortening along their second axes B_{Y} as the composite elevator belt 100 bends about the axis A. Retraction of the cavities 213 along their second axes B_{Y} decreases the radial thickness of the resin coating 212 in the tension zone TZ, thereby shifting the load carrier strands 211 in the tension zone TZ closer to the neutral bending zone NZ. By moving closer to the neutral bending zone NZ, the tensile stress experienced by the load carrier strands 211 in the tension zone TZ is reduced. Consequently, the service and fatigue life of the load carrier strands 211 in the tension zone TZ is increased.

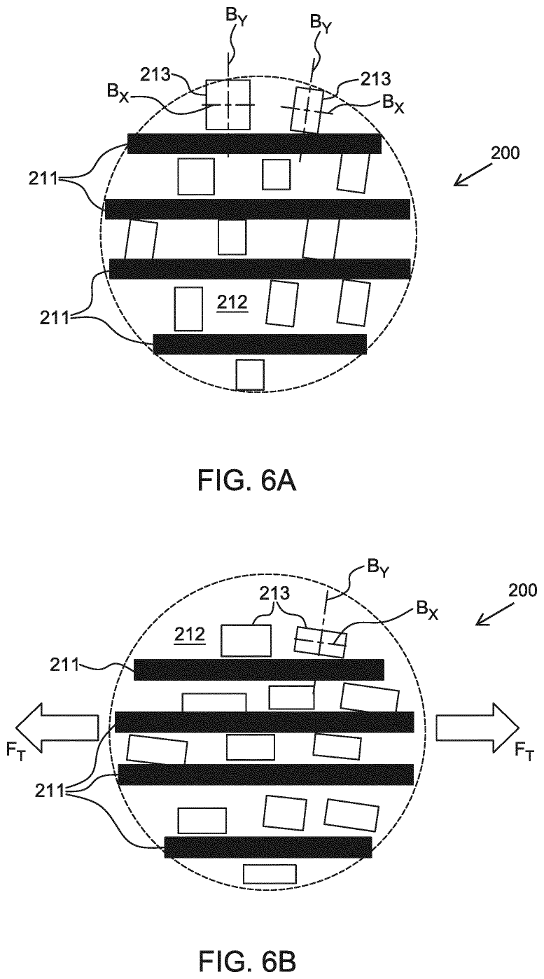

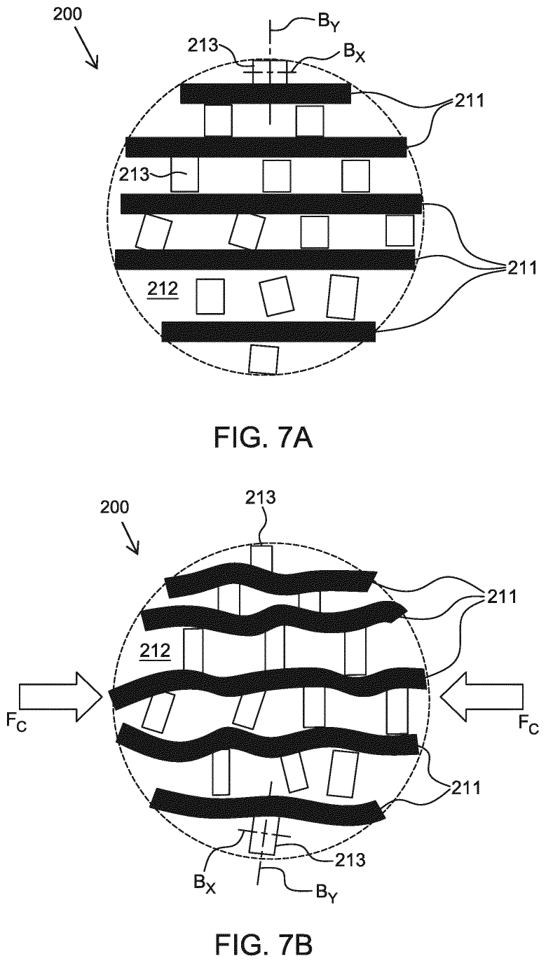

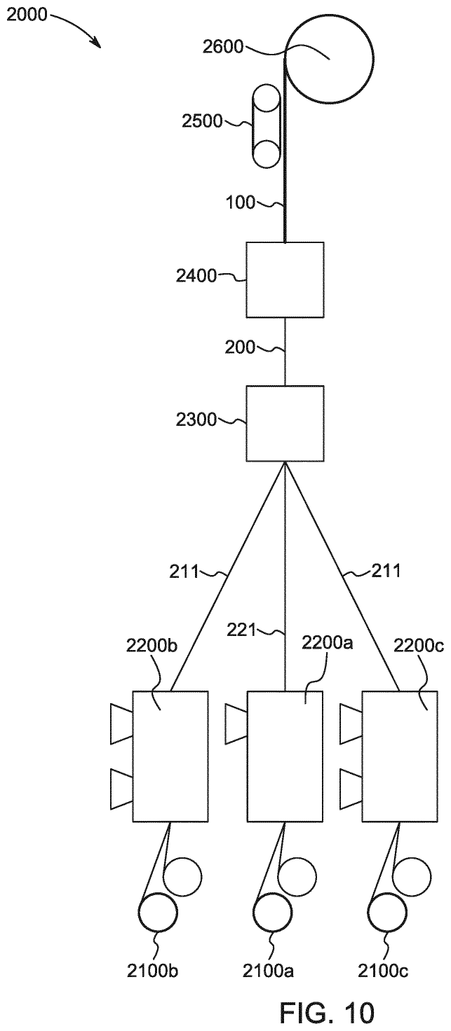

The deformation of the cavities 213 is shown in greater detail in FIGS. 6A-7B, in which the cavities 213 are shown diagrammatically as rectangles to more clearly illustrate the deformation of the cavities 213. FIG. 6A shows a schematic view of a section of the outer layer 210 in the tension zone TZ before the composite elevator belt 100 is bent around the axis A (not shown). FIG. 7A shows a schematic view of a section of the outer layer 210 in the compression zone CZ before the composite elevator belt 100 is bent around the axis A (not shown). As is apparent from FIGS. 6A and 7A, the arrangement of the outer layers 210 in the tension zone TZ and compression zone CZ is substantially the same in an unbent state of the composite elevator belt 100, except for variance in the location of the cavities 213. This variance in the location of the cavities 213 is unintentional, although it is expected due to the manufacturing process which will be described in greater detail below with reference to FIG. 10.

FIG. 6B shows the same section of the load carrier 200 as shown in FIG. 6A, but when the composite elevator belt 100 is bent around the axis A (not shown) such that the depicted belt section is in the tension zone TZ. As explained above, the cavities 213 in the tension zone TZ lengthen along their respective first axes B_{X} and shorten along their respective second axes B_{Y} due to a tension force F_{T} generated by bending the composite elevator belt 100. Shortening of the cavities 213 along their second axes B_{Y} causes the surrounding resin coating 212 to decrease in thickness perpendicular to the load carrier strands 211.

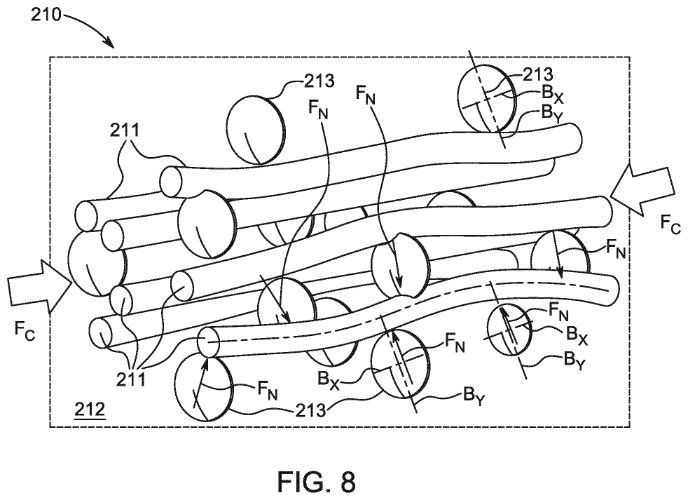

FIGS. 7B and 8 shows the same section of the load carrier 200 as shown in FIG. 7A, but when the composite elevator belt 100 is bent around the axis A (not shown) such that the depicted belt section is in the compression zone CZ. As explained above, the cavities 213 in the compression zone CZ shorten along their respective first axes B_{X} and lengthen along their respective second axes By due to a compression force F_{c} generated by bending the composite elevator belt 100. Lengthening of each cavity 213 along its second axis B_{Y} exerts a normal force F_{N} parallel to the second axis B_{Y} which displaces adjacent load carrier strands 211 in the direction of the second axis B_{Y}. Deformation of the plurality of cavities 213 exerting normal forces F_{N} at several locations along the length and around the perimeter of each load carrier strand 211 induces the load carrier strands 211 into an undulating curve. FIG. 8, showing the same section of the load carrier 200 as shown in FIG. 7B with the composite elevator belt 100 bent about the axis A (not shown), illustrates the deformation of the cavities 213 from their undeformed, substantially spherical state to their deformed oblate or partially flattened state. Additionally, FIG. 8 illustrates that the cavities 213 may be interspersed in any location between the load carrier strands 211, such that deformation of the cavities 213 exerts normal forces F_{N} in all radial directions of the load carrier strands 211. As such, the undulating curve assumed by each load carrier strand 211 may curve in three dimensions.

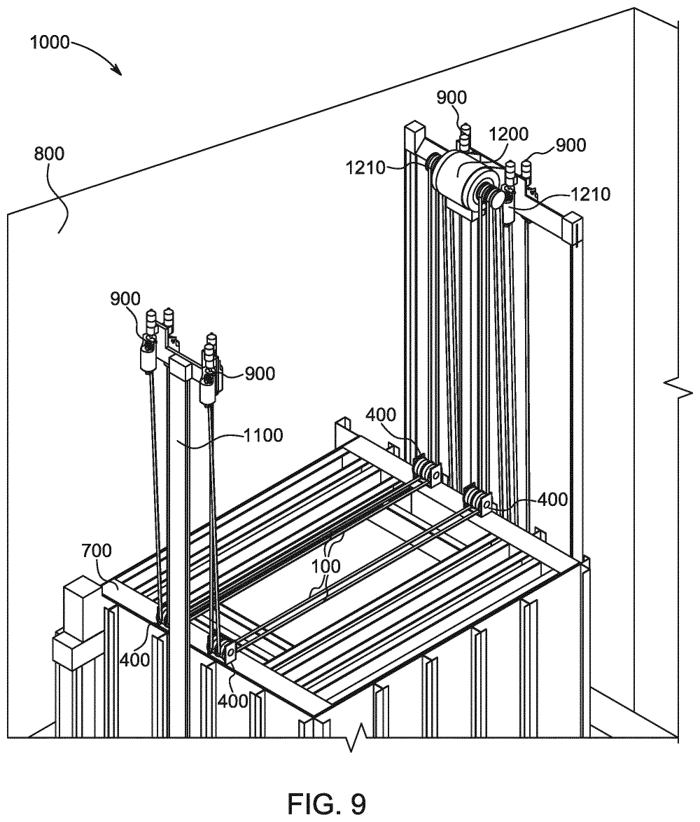

Referring now to FIG. 9, other embodiments of the present disclosure are directed to an elevator system 1000 utilizing at least one composite elevator belt 100 described with reference to FIGS. 1-8. The elevator system 1000 may include an elevator car 700 and counterweight (not shown) movable along a vertical travel path defined by an elevator shaft 800 using a plurality of composite elevator belts 100 that raise and/or lower the elevator car 700. In the embodiment shown in FIG. 9, the elevator system 1000 includes four composite elevator belts 100 configured to move the elevator car 700 and a counterweight within the elevator shaft 800. Each end of each composite elevator belt 100 may be held in a separate end termination 900 affixed to a stationary or movable component of the elevator system 1000, such as a support frame 1100, the elevator car 700, or any other load supporting component of the elevator system 1000. The composite elevator belts 100 may be routed around any number of elevator sheaves 400 to alter the direction of the tension force applied by the composite elevator belts 100 on the elevator car 700 and the counterweight. The elevator sheaves 400 may be attached to any portion of the elevator system 1000 including the support frame 1100, the elevator car 700, the counterweight, and/or a floor, a ceiling, or a wall of the hoistway to redirect the pulling force of the composite elevator belts 100 according to the design of the elevator system 1000. In some embodiments, the elevator system 1000 may utilize a one-to-one roping arrangement in which no elevator sheaves 400 are present.

The composite elevator belts 100 are further routed around drive sheaves 1210 rotatable by at least one motor arrangement 1200. The drive sheaves 1210 frictionally engage the composite elevator belts 100 between opposing ends of the composite elevator belts 100 such that rotation of the drive sheaves 1210 increases or decreases the length of the composite elevator belts 100 between a first end the of the composite elevator belt 100 and the motor arrangement 1200. Rotation of the drive sheaves 1210 thus causes the elevator car 700 to raise or lower depending on the direction of rotation of the drive sheaves 1210 and the arrangement of the counterweight, end terminations 900, and elevator sheaves 400.

As may be appreciated from the elevator system 1000 of FIG. 9, either side of the composite elevator belt 100 may be in tension or compression at different locations along the composite elevator belt 100, depending on the arrangement of the drive sheaves 1210 and the elevator sheaves 400. As such, each of the outer layers 210 may define the tension zone TZ at a first location along the longitudinal axis L of the composite elevator belt 100 and the compression zone CZ at a second location along the longitudinal axis L of the composite elevator belt 100. Further, any section of one of the outer layers 210 may define the tension zone TZ with respect to one of the drive sheaves 1210 or one of the elevator sheaves 400, and the same section of one of the outer layers 210 may define the compression zone TZ with respect to another one of the drive sheaves 2100 or another one of the elevator sheaves 400.

Having described the structure and function of the composite elevator belt 100, one skilled in the art will appreciate that a variety of materials may lend themselves to use for the various components thereof. Examples of suitable materials are generally described below and are further discussed in U.S. patent application Ser. No. 13/092,391, published as U.S. Patent Application Publication No. 2011/0259677, the entirety of which is incorporated by reference herein. Materials may be selected for their advantageous mechanical properties as well as for their compatibility with manufacturing methods suitable for making the composite elevator belt 100.

The load carrier strands 211, 221 of the at least one outer layer 210 and the central layer 220 may be made from a variety of natural and synthetic materials which are flexible yet exhibit a high breaking strength. Suitable materials for the load carrier strands 211, 221 thus include glass fiber, aramid fiber, carbon fiber, nylon fiber, basalt fiber, metallic cable, and/or combinations thereof. Some methods of manufacturing the composite elevator belt 100 may utilize inductive heating of the load carrier strands 211, 221, making it advantageous that the material of the load carrier strands 211, 221 is electrically conductive. The load carrier strands 211, 221 may each have a diameter of, for example, between 0.4 μm and 1.2 μm, such as 0.7 μm.

The resin coating 212, 222 may be made of a polymer matrix material, such as a curable epoxy resin, suitable for deposition on the load carrier strands 211, 221 and flexible when cured. However, alternative resin types may also be utilized. The resin coating 212, 222 may include additives such as fire retardants and release agent to improve the functionality and/or the manufacturing process of the resin coating 212, 222. The material of the resin coating 212, 222 may be selected based on its curing properties, such as the curing rate and the responsiveness of the curing rate to heat. Additionally, the material of the resin coating 212 of the outer layers 210 may be selected for its intermixibility with additives used to form the plurality of cavities 213, as will be described in greater detail below. The material of the resin coating 212 of the outer layers 210 may also be selected to reduce stiffness. In particular, the inclusion of the plurality of cavities 213 in the resin coating 212 may allow for the use of material having a Young's modulus of less than approximately 2 gigapascal (approximately 290,000 pounds per square inch). That is, the combined Young's modulus of the resin coating 212, taking into account the plurality of cavities 213 and any additives contained therein, may have an overall Young's modulus of approximately 2 gigpascal (GPa). The material of the resin coating 212, 222 is preferably a thermoset, or partly a thermoset and thermoplastic, or a thermoplastic material. The curing process is preferably activated by heat, or an electron beam, or ultraviolet light. The Young's modulus of the resin coating 212, 222 is preferably between 300 megapascal (MPa) and 4000 MPa. Most preferably, the Young's modulus is around 1700 MPa, i.e. 1.7 GPa.

As briefly described above, the material enclosed by each of the plurality of cavities 213 may be any of a solid, a liquid, or a gas. The operative physical property of the material is that the material permits deformation of the associated cavity 213 under tension and compression loading of the composite elevator belt 100. In some embodiments, the material enclosed by each of the cavities 213 may be a gas pocket produced by a blowing agent activated during manufacturing of the resin coating 212 of the outer layer 210. For example, a chemical blowing agent such as azodicarbonamide may be heated during manufacturing of the resin coating 212 to decompose the azodicarbonamide into gases which become trapped in the resin coating 212 as the resin coating 212 cures, defining the cavities 213 around discrete gas pockets created by the azodicarbonamide. In other embodiments, the material enclosed by each of the cavities 213 may be a deformable solid. In still other embodiments, the material enclosed by each of the cavities 213 may be a pocket of liquid.

Some of the plurality of cavities 213 may enclose a different material than other of the plurality of cavities 213. In embodiments of the composite elevator belt 100 having more than one outer layer 210, each outer layer 210 may utilize the same or a different material in the cavities 213. Each of the plurality of cavities 213 may have a diameter or outer dimension of, for example, between one-half and twice the diameter of the load carrier strands 211 in the associated outer layer 210.

The jacket layer 300 may be made of a polymer material selected for flexibility and to promote friction with the sheaves 400 and drive sheaves 1200 of the elevator system 1000. Additionally, the material of the jacket layer 300 may be selected for wear resistance of the jacket layer 300 and/or to prevent galling and other damage to the sheaves 400 and drive sheaves 1200. Suitable materials for the jacket layer 300 thus include curable resins such as urethanes, in particular thermoplastic polyurethane (TPU). The material of the jacket layer 300 may be softer than the material of the load carrier 200 by, for example, a factor of ten.

Other embodiments of the present disclosure are directed to a method of manufacturing the composite elevator belt 100 described with reference to FIGS. 1-8 and FIGS. 11A-20B. Referring now to FIG. 10, an apparatus 2000 at least partially forms each of the at least one outer layers 210 and the central layer 220 individually before the at least one outer layer 210 and the central layer 220 are joined in a final forming stage. As shown in FIG. 10, the apparatus 2000 includes a first roving coil rack 2100a associated with the central layer 220, a second roving coil rack 2100b associated with a first of the outer layers 210, and a third roving coil rack 2100c associated with a second of the outer layers 210. The roving coil racks 2100a-2100c hold the load carrier strands 211, 221 for the outer layers 210 and central layer 220, respectively. A first injection chamber 2200a associated with the central layer 220 and the first roving coil rack 2100a contains a bath of liquid resin for forming the resin coating 222 of the central layer 220. The load carrier strands 221 of the central layer 220 are pulled from the first roving coil rack 2100a and through the first injection chamber 2200a to impregnate the load carrier strands 221 with liquid resin. Similarly, second and third injection chambers 2200b, 2200c associated with the outer layers 220 and the second and third roving coil racks 2100b, 2100c each contain a bath of liquid resin for forming the resin coating 212 of the outer layers 210. The load carrier strands 211 of the two outer layers 210 are pulled from the second and third roving coil racks 2100b, 2100c and through the second and third injection chambers 2200b, 2200c, respectively, to impregnate the load carrier strands 211 with liquid resin.

The liquid resin in the second and third injection chambers 2200b, 2200c may be intermixed with an additive suitable for forming the plurality of cavities 213 in the resin coating 212. In some embodiments, the additive may be a blowing agent, such as azodicarbonamide, which decomposes into gas during the subsequent curing of the liquid resin. In other embodiments, the additive may be solid particles, liquid particles, or gas particles. The amount or volume of the chosen additive intermixed with the liquid resin may be governed to control the total volume of the cavities 213 ultimately defined in the finished resin coating 212. Measures may be undertaken to ensure that the additive is homogenously intermixed with the liquid resin so that the cavities 213 are subsequently defined having substantially uniform spacing in the finished resin coating 212. In some embodiments, the load carrier strands 211, 221 may be coated with an additive, such as a blowing agent, prior to being pulled into the injection chambers 2200a, 2200b, 2200c, alternatively or in addition to the additive intermixed with the liquid resin.

After the load carrier strands 211, 221 of the outer layers 210 and the central layer 220 are impregnated with liquid resin, the load carrier strands 211, 221 are pulled out of the injection chambers 2200a-2200c and into a forming and curing die 2300 where the outer layer 210 and central layer 220 are joined together. When entering the forming and curing die 2300, the liquid resin impregnating the load carrier strands 211, 221 remains in an at least partially liquid phase to facilitate adhesion of the outer layers 210 to the central layer 220. Within the forming and curing die 2300, final shaping of the outer layers 210 and the central layer 220 is performed, and the liquid resin impregnating the load carrier strands 211, 221 is cured to form the resin coatings 212, 222 of the outer layers 210 and central layer 220. Curing of the resin coatings 212, 222 may be achieved, for example, by induction heating of the load carrier strands 211, 221 and/or the liquid resin.

In embodiments of the composite elevator belt 100 in which a blowing agent is intermixed with the liquid resin of the outer layers 210, the forming and curing die 2300 may also provide heat to decompose the blowing agent prior to or concurrently with the curing of the resin coating 212 of the outer layers 210. Decomposition of the blowing agent forms gas pockets around which the cavities 213 of the resin coating 212 are defined as the resin coating 212 cures. Similarly, in embodiments of the composite elevator belt 100 in which solid particles and/or liquid particles are intermixed with the liquid resin of the outer layers 210, the resin coating 212 cures around the liquid particles and/or solid particles to define the cavities 213.

After curing is completed in the forming and curing die 2300, the load carrier 200, now including all of the outer layers 210 and the central layer 220 joined together, may optionally be pulled through a jacket extruder 2400 which deposits the jacket layer 300 onto external surfaces of the load carrier 100. The composite elevator belt 100 exits the jacket extruder 2400 fully formed.

A tractor 2500 located downstream of the jacket extruder 2400 and/or the forming and curing dies 2300 applies a pulling force to unwind the load carrier strands 211, 221 from the roving coil racks 2100a-2100c and pull the load carrier strands 211, 221 through the injection chambers 2200a-2200c, the forming and curing die 2300, and, optionally, the jacket extruder 2400. The finished composite elevator belt 100 is then wound into a spool by a spooler 2600.

Utilizing the apparatus 2000 described above, a method for making a composite elevator belt 100 includes partially forming the at least one outer layer 210 of the load carrier 100 by impregnating the load carrier strands 211 of the at least one outer layer 210 with liquid resin in the second and third injection chambers 2100b, 2100c. The liquid resin in the second and third injection chambers 2100b, 2100c may be intermixed with an additive selected from a group consisting of deformable materials and blowing agents. The central layer 220 of the load carrier 100 may be formed in substantially the same manner as the outer layers 210, namely by impregnating the load carrier strands 221 of the central layer 220 with liquid resin in the first injection chamber 2100a. The outer layers 210 and the central layer 220 may then be pulled from the forming and curing die 2300 to join the outer layers 210 to the central layer 220 and cure the liquid resin of the outer layers 210 and the central layer 220. Curing the liquid resin of the outer layers 210 forms a solid resin coating defining the plurality of cavities 213 around the additive intermixed with the liquid resin.

While the apparatus 2000 and method described above provide one embodiment for manufacturing the composite elevator belt 100, variations may be made to suit the requirements of a particular application. For example, the central layer 220, which, in the present embodiment, lacks the plurality of cavities 213 present in the outer layers 210, may be at least partially formed using a different process than the outer layers 210, or the central layer 220 may be pre-manufactured and joined to the partially-formed outer layers 210 in the forming and curing die 2300. In other embodiments, the central layer 220 may be made similarly to the outer layers 210 such that cavities 213 are formed in the central layer 220 in addition to the outer layers 210. In still other embodiments, additional tooling may be added to the apparatus 2000 to perform additional forming operations to the composite elevator belt 100, or to add further layers to the composite elevator belt 100. In still other embodiments, the load carrier 200 may include an outer layer 210 on only one side of the central layer 220, or the load carrier 200 may include multiple outer layers 210 stacked on and joined with each other on any side or sides of central layer 220.

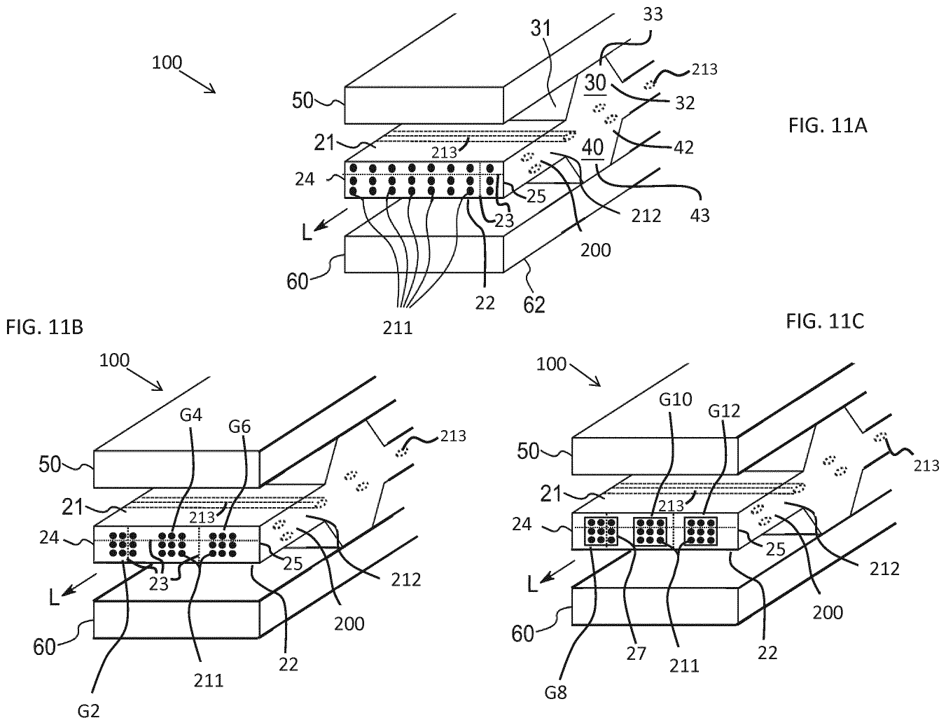

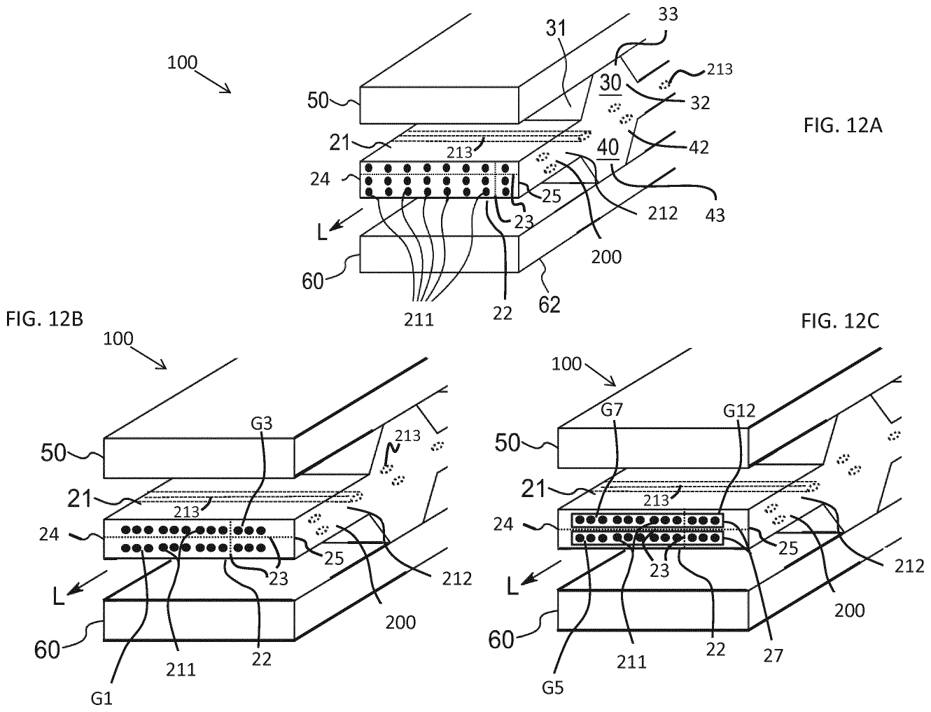

FIGS. 11A and 12A illustrate a portion of a composite elevator belt 100 according to one embodiment of the present disclosure. The composite elevator belt 100 includes at least one fiber or strand 211 encased in a resin coating 212 and extending in a longitudinal direction L of the composite elevator belt 100 to form a load carrier 200. The at least one fiber or strand 10 may be continuous along the length of the composite elevator belt 100. The load carrier strands 211 in this embodiment are arranged in an ordered pattern. The ordered pattern shown in the figure is a square arrangement. The strands 211 are positioned side-by-side at their widest part. This positioning allows for an inter-strand space 23 free of load carrier strands to be provided between the load carrier strands 211. The inter-strand space 23 forms a straight continuous channel which travels from a first terminal end 24 of the load carrier 26 to an opposite terminal end 25 of the load carrier 26. Alternatively and/or additionally to this, the first terminal end 24 can also be located at the top surface 21 and the opposite terminal end 25 can be located on the bottom surface 22. Such an arrangement of strands 211 facilitates a controlled buckling of the elevator belt 100 and serves to enhance its bending performance. A first plurality of teeth 30 is disposed on a top surface 21 of the resin coating 212 and extends outwardly therefrom. Each of the first plurality of teeth 30 has a root portion 32 associated with the resin coating 212 and a tip portion 33 extending from the root portion 32 away from the resin coating 212. Each of the first plurality of teeth 30 further includes a pair of flank surfaces 31 extending along the top surface 21 of the resin coating 20 in a direction not parallel to and, in some embodiments, substantially perpendicular to the longitudinal direction L. The space between adjacent teeth 30 form grooves associated with top surface 21 the resin coating 212 (not shown). Similarly, a second plurality of teeth 40 is disposed on a bottom surface 22 of the resin coating 212 and extends outwardly therefrom. Each of the second plurality of teeth 40 has a root portion 42 associated with the resin coating 212 and a tip portion 43 extending from the root portion 42 away from the core layer 212. Each of the second plurality of teeth 40 has a pair of flank surfaces 41 (not shown) extending along the bottom surface 22 of the resin coating 212 in a direction not parallel to and, in some embodiments, substantially perpendicular to the longitudinal direction L. The space between adjacent teeth 40 form grooves associated with bottom surface 22 the core (not shown). Together, the strands 211, resin coating 212, and first and second pluralities of teeth 30, 40 define the load carrier 200 that carries tension in the longitudinal direction L when the composite elevator belt 100 is in operation supporting a component of an elevator system 1000 (see FIG. 9).

A first jacket layer 50 is provided and extends parallel to the resin coating 212 in the longitudinal direction L. The first jacket layer 50 is spaced apart from the resin coating 212 by the first plurality of teeth 30 and is associated with the tip portions 33 of each of the first plurality of teeth 30. Between each adjacent pair of the first plurality of teeth 30, a transverse groove is defined by the top surface 21 of the core layer 212, a bottom surface 52 of the first jacket layer 50, and the flanks 31 of the adjacent teeth 30. Similarly, a second jacket layer 60 is provided and extends parallel to the resin coating 212 in the longitudinal direction L. The second jacket layer 60 is spaced apart from the resin coating 212 by the second plurality of teeth 40 and is associated with the tip portions 43 of each of the second plurality of teeth 40. Between each adjacent pair of the second plurality of teeth 40, a transverse groove is defined by the bottom surface 22 of the resin coating 212, a top surface 61 of the second jacket layer 60, and the flanks 41 of the adjacent teeth 40. These transverse grooves are void of resin coating 212 and jacket layer 50, 60 material. A top surface 51 of the first jacket layer 50 and a bottom surface 62 of the second jacket layer 60 define contact surfaces of the composite elevator belt 100 and are configured for tractive, frictional engagement with a running surface of a sheave 400 or drive sheave.

The resin coating 212 defines a plurality of deformable cavities 213 interspersed throughout. The plurality of deformable cavities 213 are positioned adjacent to the load carrier strands 211, meaning each of the cavities 213 is spaced apart from the load carrier strands 211, in any direction from the longitudinal axis L, within the resin coating 212. Each of the plurality of cavities 213 encloses a material, which may be a solid, a liquid, or a gas, having a greater deformability than the deformability of the surrounding resin coating 212. The plurality of cavities 213 may account for approximately one third of the total volume of the resin coating 212, although the ratio of the volume of the cavities 213 to the total volume of the resin coating 212 may be adjusted to attain various levels of stress reduction in the composite elevator belt 100, as described in detail with reference to FIG. 5. The cavities 213 are polygonal in shape. The shape of the cavities 213 may be dictated by the method of production of the resin coating 212, as was earlier described. Additionally, the exact spacing and location of each deformable cavity 213 within the resin coating 212 may be a product of inherent variability in the manufacturing process during which the cavities 213 are defined. However, many properties of the cavities 213 may be predetermined despite variabilities in the manufacturing process. For example, the size of the cavities 213 and the ratio of the total volume of the cavities 213 per unit volume of the resin coating 212 may be predetermined and controlled throughout the manufacturing process. As such, the plurality of deformable cavities 213 may be differentiated from unintentionally occurring voids and/or discontinuities that would naturally occur in the resin coating 212. For this reason, the plurality of cavities 213 may be referred to as being predetermined or predefined. Preferably, the distance in longitudinal belt direction L between adjacent cavities 213 is equal to the distance between adjacent teeth. This arrangement reinforces the buckling process in an optimal way.

FIG. 11B illustrates a portion of a composite elevator belt 100 according to one embodiment of the present disclosure. The belt 100 is the same as the one illustrated in FIG. 11A with the exception of the arrangement of the load carrier strands 211. In this embodiment, the inter-strand space 23 varies throughout the cross-section of the load carrier 200 such that the strands 211 form three groups G2, G4, G6 of load carrier strands. The groups G2, G4, G6 are spaced apart laterally such that a larger space 23 which is free of load carrier strands exists between the groups G2 and G4, and between groups G4 and G6.

Each individual strand 211, or a group of strands G2, G4, G6 can be treated with a further material 27, preferably they are treated with this further material 27 before they are covered by the resin coating 212. The further material 27 can be applied to each strand 211 individually or to a group of strands G2, G4, G6. The further material 27 can be selected from the group consisting of: a resin material, a polymer matrix material, an adhesive material, e.g., sizing, a thermoset material, a thermoplastic material, or any combination thereof. The strands 10 shown in example FIG. 11B may optionally comprise a sizing.

The example shown in FIG. 11C is the same as the example shown in FIG. 11B, however each group of strands G8, G10, G12 is covered with a first further material 27. The first further material 27 which comprises the group of strands G8, G10, G12 is embedded in the resin coating 212. The individual strands 10 may also be covered with a second further material 27, wherein the second further material 27 can be the same as or different to the first further material 27. For example, the second further material 27 can be a silicon matrix material, whilst the first further material 27 can be a polymer matrix material. Distribution of the load carrier strands 211 into such groups G2, G4, G6, G8, G10, G12, can help improve the buckling properties and consequently the bending performance of the composite elevator belt 100.

FIG. 12B illustrates another example of the embodiment shown in FIGS. 11A and 12A in which the load carrier strands 211 can be grouped. The inter-strand space 23 illustrated in FIG. 12B varies throughout the cross-section of the load carrier 200 such that the strands 211 form two groups G1, G3 of load carrier strands. The groups G1, G3 are spaced apart vertically.

Each individual strand 211 or each individual group of strands G1, G3 can be treated with a further material 27, preferably they are treated with this further material 27 before they are covered by the resin coating 212. The further material 27 can be applied to each strand 211 individually or to a group of strands G1, G3. The further material 27 can be selected from the group consisting of: a resin material, a polymer matrix material, an adhesive material, e.g., sizing, a thermoset material, a thermoplastic material, or any combination thereof. The strands 211 shown in example FIG. 12B may optionally comprise a sizing.

The example shown in FIG. 12C is the same as the example shown in FIG. 12B, however each of the group of strands G5, G7 is covered with a first further material 27. The first further material 27 which comprises the group of strands G5, G7 is embedded in the resin coating 212. The individual strands 211 may also be covered with a second further material 27, wherein the second further material 27 can be the same as or different to the first further material 27. For example, the second further material 27 can be a sizing, whilst the first further material 27 can be a polymer matrix material. Distribution of the load carrier strands 10 into such groups G1, G3, G5, G7 can help improve the buckling properties and consequently the bending performance of the composite elevator belt 100.

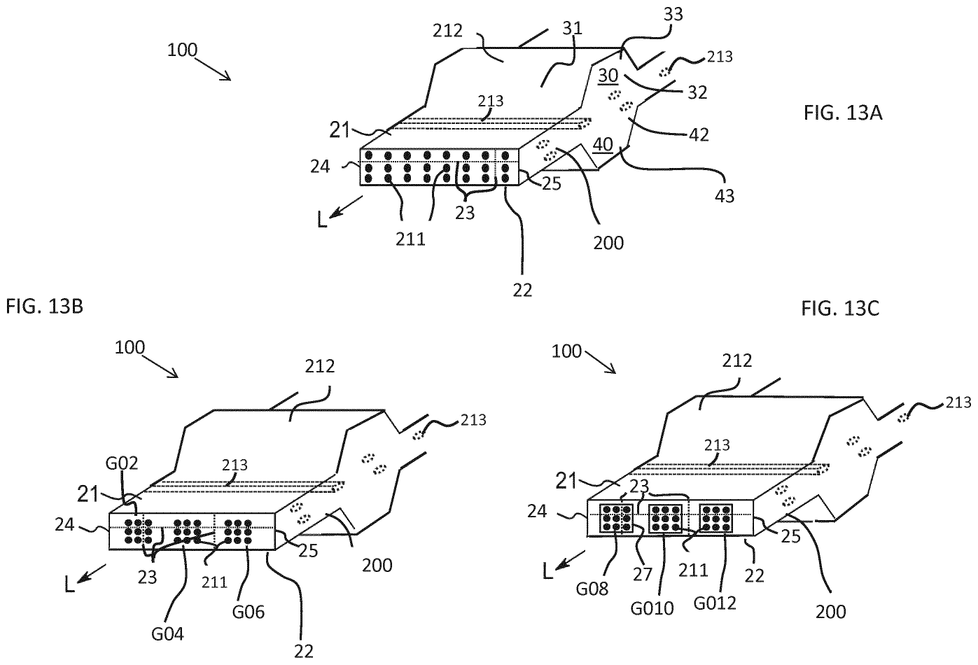

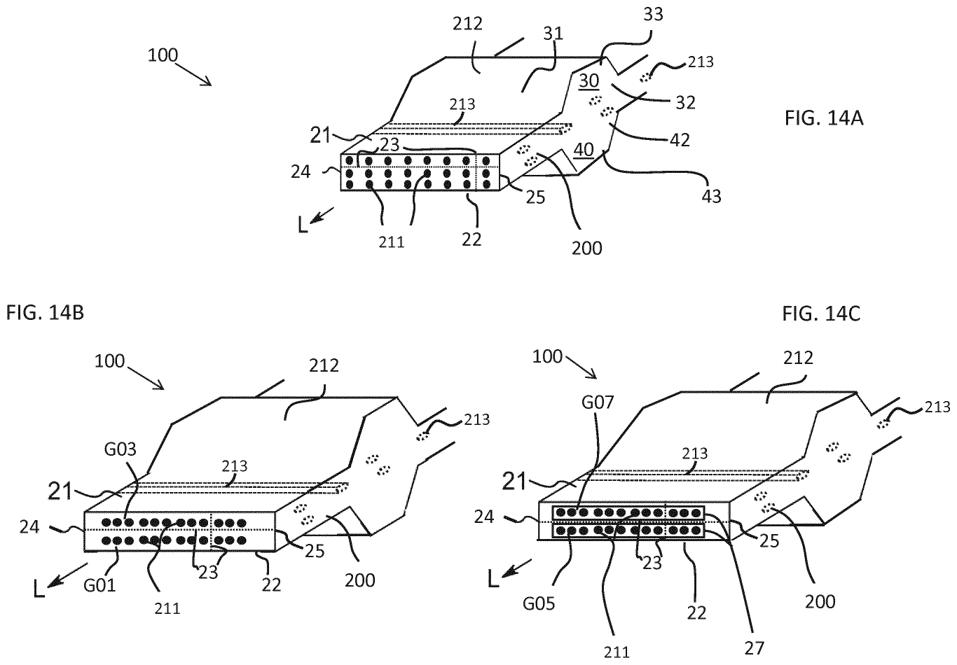

FIGS. 13A and 14A illustrate a portion of a composite elevator belt 100 according to one embodiment of the present disclosure. The composite elevator belt 100 includes at least one fiber or strand 211 encased in a resin coating 212 and extending in a longitudinal direction L of the composite elevator belt 100 to form a load carrier 200. The at least one fiber or strand 211 may be continuous along the length of the composite elevator belt 100. The load carrier strands 211 in this embodiment are arranged in an ordered pattern. The ordered pattern shown in the figure is a square arrangement. The strands 211 are positioned side-by-side at their widest part. This positioning allows for an inter-strand space 23 free of load carrier strands to be provided between the load carrier strands 211. The inter-strand space 23 forms a straight continuous channel which travels from a first terminal end 24 of the load carrier 26 to an opposite terminal end 25 of the load carrier 200. Alternatively and/or additionally to this, the first terminal end 24 can also be located at the top surface 21 and the opposite terminal end 25 can be located on the bottom surface 22. Such an arrangement of strands 211 facilitates a controlled buckling of the elevator belt 100 and serves to enhance its bending performance. A first plurality of teeth 30 is disposed on a top surface 21 of the resin coating 212 and extends outwardly therefrom. Each of the first plurality of teeth 30 has a root portion 32 associated with the resin coating 212 and a tip portion 33 extending from the root portion 32 away from the resin coating 212. Each of the first plurality of teeth 30 further includes a pair of flank surfaces 31 extending along the top surface 21 of the resin coating 212 in a direction not parallel to and, in some embodiments, substantially perpendicular to the longitudinal direction L. The space between adjacent teeth 30 form grooves associated with top surface 21 the resin coating 212 (not shown). Similarly, a second plurality of teeth 40 is disposed on a bottom surface 22 of the resin coating 212 and extends outwardly therefrom. Each of the second plurality of teeth 40 has a root portion 42 associated with the resin coating 212 and a tip portion 43 extending from the root portion 42 away from the resin coating 212. Each of the second plurality of teeth 40 has a pair of flank surfaces 41 (not shown) extending along the bottom surface 22 of the resin coating 212 in a direction not parallel to and, in some embodiments, substantially perpendicular to the longitudinal direction L. The space between adjacent teeth 40 form grooves associated with bottom surface 22 the core (not shown). Together, the strands 211, resin coating 212, and first and second pluralities of teeth 30, 40 define the load carrier 200 that carries tension in the longitudinal direction L when the composite elevator belt 100 is in operation supporting a component of an elevator system 1000 (see FIG. 9).

The resin coating 212 defines a plurality of deformable cavities 213 interspersed throughout. The plurality of deformable cavities 213 are positioned adjacent to the load carrier strands 211, meaning each of the cavities 213 is spaced apart from the load carrier strands 211, in any direction from the longitudinal axis L, within the resin coating 212. Each of the plurality of cavities 213 encloses a material, which may be a solid, a liquid, or a gas, having a greater deformability than the deformability of the surrounding resin coating 212. The plurality of cavities 213 may account for approximately one third of the total volume of the resin coating 212, although the ratio of the volume of the cavities 213 to the total volume of the resin coating 212 may be adjusted to attain various levels of stress reduction in the composite elevator belt 100, as described in detail with reference to FIG. 5. The cavities 213 are polygonal in shape. The shape of the cavities 213 may be dictated by the method of production of the resin coating 212, as was earlier described. Additionally, the exact spacing and location of each deformable cavity 213 within the resin coating 212 may be a product of inherent variability in the manufacturing process during which the cavities 213 are defined. However, many properties of the cavities 213 may be predetermined despite variabilities in the manufacturing process. For example, the size of the cavities 213 and the ratio of the total volume of the cavities 213 per unit volume of the resin coating 212 may be predetermined and controlled throughout the manufacturing process. As such, the plurality of deformable cavities 213 may be differentiated from unintentionally occurring voids and/or discontinuities that would naturally occur in the resin coating 212. For this reason, the plurality of cavities 213 may be referred to as being predetermined or predefined. Preferably, the distance in longitudinal belt direction L between adjacent cavities 213 is equal to the distance between adjacent teeth. This arrangement reinforces the buckling process in an optimal way.

FIG. 13B illustrates a portion of a composite elevator belt 100 according to one embodiment of the present disclosure. The belt 100 is the same as the one illustrated in FIG. 13A with the exception of the arrangement of the load carrier strands 211. In this embodiment, the inter-strand space 23 varies throughout the cross-section of the load carrier 200 such that the strands 211 form three groups G02, G04, G06 of load carrier strands. The groups G02, G04, G06 are spaced apart laterally such that a larger space 23 which is free of load carrier strands exists between the groups G02 and G04, and between groups G04 and G06.

Each individual strand 211, or each individual group of strands G02, G04, G06 can be treated with a further material 27, preferably they are treated with this further material 27 before they are covered by the resin coating 212. The further material 27 can be applied to each strand 211 individually or to a group of strands G02, G04, G06. The further material 27 can be selected from the group consisting of: a resin material, a polymer matrix material, an adhesive material, e.g., sizing, a thermoset material, a thermoplastic material, or any combination thereof. The strands 211 shown in example FIG. 13B may optionally comprise a sizing.

The example shown in FIG. 13C is the same as the example shown in FIG. 13B, however each group of strands G08, G010, G012 is covered with a first further material 27. The first further material 27 which comprises the group of strands G08, G010, G012 is embedded in the resin coating 212. The individual strands 211 may also be covered with a second further material 27, wherein the second further material 27 can be the same as or different to the first further material 27. For example, the second further material 27 can be a sizing, whilst the first further material 27 can be a polymer matrix material. Distribution of the load carrier strands 211 into such groups G02, G04, G06, G08, G010, G012, can help improve the buckling properties and consequently the bending performance of the composite elevator belt 100.

FIG. 14B illustrates another example of the embodiment shown in FIGS. 13A and 14A in which the load carrier strands 211 can be grouped. The inter-strand space 23 illustrated in FIG. 14B varies throughout the cross-section of the load carrier 200 such that the strands 211 form two groups G01, G03 of load carrier strands. The groups G01, G03 are spaced apart vertically.

Each individual strand 211 or each individual group of strands G01, G03 can be treated with a further material 27, preferably they are treated with this further material 27 before they are covered by the resin coating 212. The further material 27 can be applied to each strand 211 individually or to a group of strands G01, G03. The further material 27 can be selected from the group consisting of: a resin material, a polymer matrix material, an adhesive material, e.g., sizing, a thermoset material, a thermoplastic material, or any combination thereof. The strands 211 shown in example FIG. 14B may optionally comprise a sizing.

The example shown in FIG. 14C is the same as the example shown in FIG. 14B, however each of the group of strands G05, G07 is covered with a first further material 27. The first further material 27 which comprises the group of strands G05, G07 is embedded in the resin coating 212. The individual strands 211 may also be covered with a second further material 27, wherein the second further material 27 can be the same as or different to the first further material 27. For example, the second further material 27 can be a sizing, whilst the first further material 27 can be a polymer matrix material. Distribution of the load carrier strands 211 into such groups G01, G03, G05, G07 can help improve the buckling properties and consequently the bending performance of the composite elevator belt 100.

In each of the examples illustrated in FIGS. 13A-13C, and 14A-14C, the resin coating 212 can also act as the jacket layer and be placed in contact with components parts of an elevator system, for example, a traction sheave.

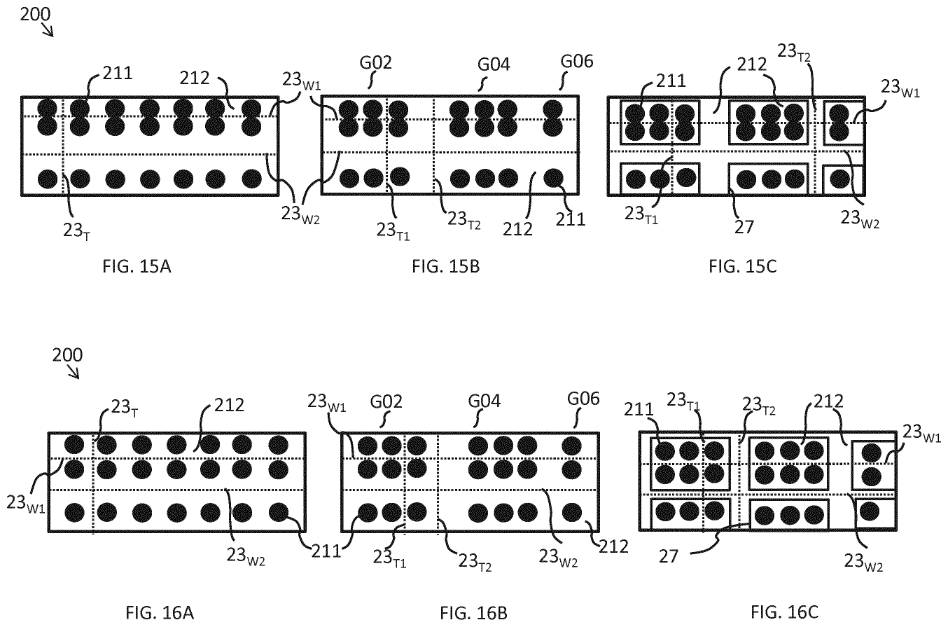

FIG. 15A depicts a cross-sectional view of a load carrier 200 according to an embodiment of the present disclosure. Although not shown, the load carrier 200 can comprise a first plurality of teeth, or a first plurality of teeth and a second plurality of teeth, or no teeth at all. The load carrier 200 may also comprise cavities 213 as shown in FIGS. 11A to 14C. The load carrier 200 comprises a plurality of strands 211 encased in a resin coating 212 wherein the strands 211 are arranged such that a first space between the strands in the width direction 23_{W1} and a second space between the strands in the width direction 23_{W2} exists. The first space 23_{W1} is preferably 0 μm therefore, the strands 211 are touching, whilst the second space 23_{W2} covers a distance preferably in a range of 3 to 5 μm. The space between the strands in the thickness direction 23_{T} covers a constant distance preferably in a range from 7 to 20 μm.

The distribution of strands 211 in FIG. 15B is based on FIG. 15A, wherein the strands 211 are grouped into a plurality of groups G02, G04, G06. The load carrier strands 211 are arranged such that a first space between the strands in the width direction 23_{W1} and a second space between the strands in the width direction 23_{W2} exists. The first space 23_{W1} is preferably 0 μm therefore, the strands 211 are touching, whilst the second space 23_{W2} covers a distance of 10 μm. Due to the grouping of the strands 211, the space between the strands in the thickness direction 23_{T} no longer covers a constant distance of 4 to 5 μm. Instead, a first space in the thickness direction 23_{T1} and a second space in the thickness direction 23_{T2} exists, wherein the first space 23_{T1} refers to the inter-strand space between the strands within a group and thus covers a smaller distance, whilst the second space 23_{T2} refers to the space between each group and covers a larger distance.

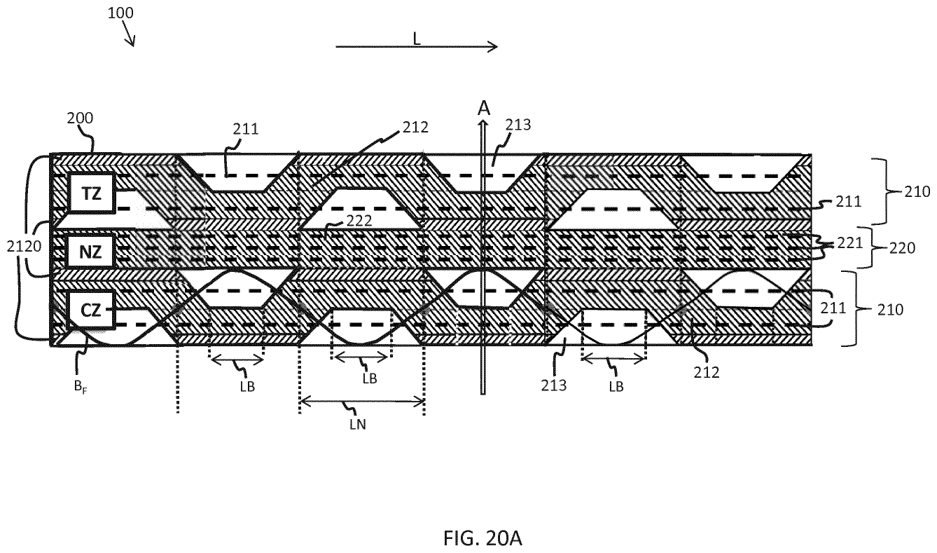

FIG. 15C is the same as FIG. 19B however the groups of strands G02, G04, G06 are covered with a further material 27. The inter-strand space remains unchanged.

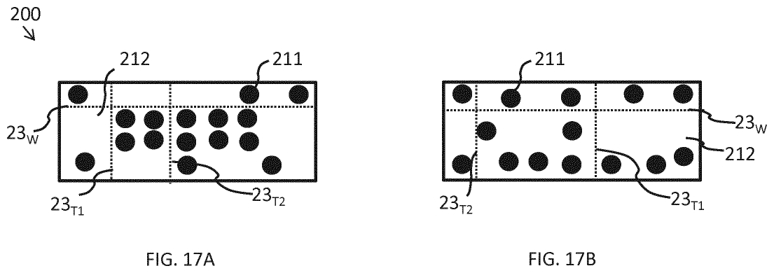

FIG. 16A depicts a cross-sectional view of a load carrier 200 according to an embodiment of the present disclosure. Although not shown, the load carrier 200 can comprise a first plurality of teeth, or a first plurality of teeth and a second plurality of teeth, or no teeth at all. The load carrier 200 may also comprise cavities 213 as shown in FIGS. 11A to 14C. The load carrier 200 comprises a plurality of strands 211 encased in a resin coating 212 wherein the strands 211 are arranged such that a first space between the strands in the width direction 23_{W1} and a second space between the strands in the width direction 23_{W2} exists. The first space 23_{W1} covers a distance greater than 0 μm, preferably 0.5 to 3 μm, therefore, the strands 211 do not touch, whilst the second space 23_{W2} covers a greater distance than the first space in the width direction. 23_{W1}. In this example, the second space 23_{W2} covers a distance preferably in a range from 3 to 10 μm. The space between the strands in the thickness direction 23_{T} is unchanged from FIG. 16A and covers a constant distance preferably in a range from 7 to 20 μm.

The distribution of strands 211 in FIG. 16B is based on FIG. 16A, wherein the strands 211 are grouped into a plurality of groups G02, G04, G06. The load carrier strands 211 are arranged such that a first space between the strands in the width direction 23_{W1} and a second space between the strands in the width direction 23_{W2} exists. The first space 23_{W1} covers a distance greater than 0 μm, preferably 0.5 to 3 μm, therefore, the strands 211 do not touch, whilst the second space 23_{W2} covers a greater distance than the first space in the width direction. 23_{W1}. In this example, the second space 23_{W2} covers a distance of about 8 to 10 μm. Due to the grouping of the strands 211, the space between the strands in the thickness direction 23_{T} is no longer a constant distance. Instead, a first space in the thickness direction 23_{T1} and a second space in the thickness direction 23_{T2} exists, wherein the first space 23_{T1} refers to the inter-strand space between the strands within a group and thus covers a smaller distance, whilst the second space 23_{T2} refers to the space between each group and covers a larger distance. The inter strand space within a group 23_{T1} is preferably 2 μm or less.

FIG. 16C is the same as FIG. 16B however the groups of strands G02, G04, G06 are covered with a further material 27. The distance covered by the inter-strand space 23_{T1}, 23_{T2}, 23_{W1}, 23_{W2} remains unchanged,

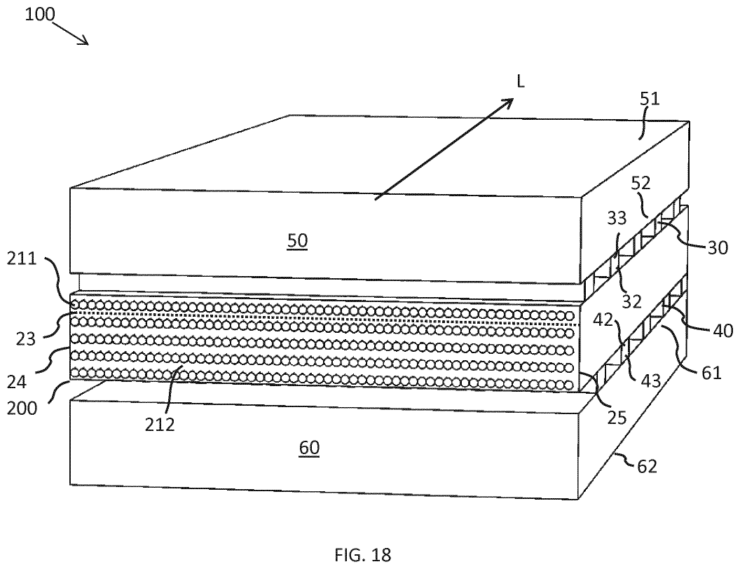

FIGS. 17A and 17B depict a cross-sectional view of a load carrier 200 according to an embodiment of the present disclosure. Although not shown, the load carrier 200 can comprise a first plurality of teeth, or a first plurality of teeth and a second plurality of teeth, or no teeth at all. The load carrier 200 may also comprise cavities 213 as shown in FIGS. 11A to 14C. The load carrier 200 comprises a plurality of strands 211 encased in a resin coating 212 wherein the strands 211 are arranged in a random orientation. A first space between the strands 211 in the width direction 23_{w} may or may not cover the same distance as a second space in the width direction (not shown). A first space between the strands 211 in the thickness direction 23_{T1}, covers a significantly larger distance than a second space between the strands 23_{T2}. Due to the random orientation of strands, the distance covered by the inter-strand space 23 can be any distance, in any of the thickness or width direction. The strand 211 arrangement shown in FIG. 17A has a higher concentration of strands in the center of the load carrier 200 whereas the strand arrangement in FIG. 17B has a higher concentration of strands 10 at the periphery of the load carrier 200. Such an arrangement of load carrier strands 211 can be advantageous when tailoring the flexibility of the load carrier 200.

The load carrier 200 cross-sections depicted in any of FIGS. 15A to 17B can be applied to any composite elevator belt 100 according to any embodiment of the present disclosure. For example, the load carrier 200 can further comprise a first plurality of teeth; or a first plurality of teeth and a second plurality of teeth; a first jacket layer; or a first jacket layer and a second jacket layer; or any combination thereof.

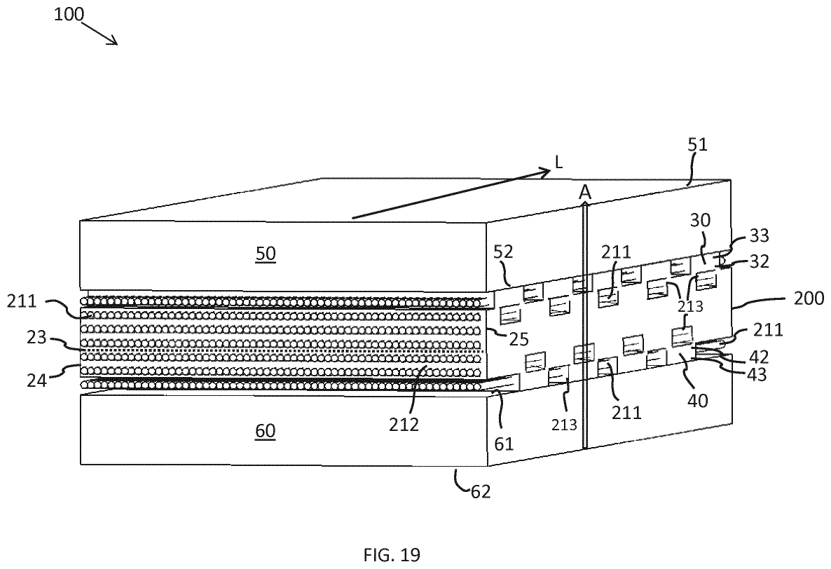

FIG. 18 depicts a composite elevator belt 100 according to an embodiment of the present disclosure. The composite elevator belt 100 includes at least one fiber or strand 211 encased in a resin coating 212 and extending in a longitudinal direction L of the composite elevator belt 100 to form a load carrier 200. The at least one fiber or strand 211 may be continuous along the length of the composite elevator belt 100. The load carrier strands 211 in this embodiment are arranged in an ordered pattern. The strands 211 are positioned side-by-side at their widest part. This positioning allows for an inter-strand space 23 free of load carrier strands to be provided between the load carrier strands 211. The inter-strand space 23 forms a straight continuous channel which travels from a first terminal end 24 of the load carrier 26 to an opposite terminal end 25 of the load carrier 200. In this particular example, there is no space 23 in the thickness direction. Such an arrangement of strands 211 facilitates a controlled buckling of the elevator belt 100 and serves to enhance its bending performance. A first plurality of teeth 30 is disposed on a top surface 21 of the resin coating 212 and extends outwardly therefrom. Each of the first plurality of teeth 30 has a root portion 32 associated with the resin coating 212 and a tip portion 33 extending from the root portion 32 away from the resin coating 212. Each of the first plurality of teeth 30 further includes a pair of flank surfaces 31 extending along the top surface 21 (not shown) of the resin coating 212 in a direction not parallel to and, in some embodiments, substantially perpendicular to the longitudinal direction L. The space between adjacent teeth 30 form grooves associated with top surface 21 of the resin coating 212 (not shown). Similarly, a second plurality of teeth 40 is disposed on a bottom surface 22 (not shown) of the resin coating 212 and extends outwardly therefrom. Each of the second plurality of teeth 40 has a root portion 42 associated with the resin coating 212 and a tip portion 43 extending from the root portion 42 away from the resin coating 212. Each of the second plurality of teeth 40 has a pair of flank surfaces 41 (not shown) extending along the bottom surface 22 of the resin coating 212 in a direction not parallel to and, in some embodiments, substantially perpendicular to the longitudinal direction L. The space between adjacent teeth 40 form grooves associated with bottom surface 22 the resin coating 212 (not shown). Together, the strands 211, resin coating 212, and first and second pluralities of teeth 30, 40 define the load carrier 200 that carries tension in the longitudinal direction L when the composite elevator belt 100 is in operation supporting a component of an elevator system 1000 (see FIG. 9).

A first jacket layer 50 is provided and extends parallel to the resin coating 212 in the longitudinal direction L. The first jacket layer 50 is spaced apart from the resin coating 212 by the first plurality of teeth 30 and is associated with the tip portions 33 of each of the first plurality of teeth 30. Between each adjacent pair of the first plurality of teeth 30, a transverse groove is defined by the top surface 21 of the resin coating 212, a bottom surface 52 of the first jacket layer 50, and the flanks 31 of the adjacent teeth 30. Similarly, a second jacket layer 60 is provided and extends parallel to the resin coating 212 in the longitudinal direction L. The second jacket layer 60 is spaced apart from the resin coating 212 the second plurality of teeth 40 and is associated with the tip portions 43 of each of the second plurality of teeth 40. Between each adjacent pair of the second plurality of teeth 40, a transverse groove is defined by the bottom surface 22 of the resin coating 212, a top surface 61 of the second jacket layer 60, and the flanks 41 of the adjacent teeth 40. These transverse grooves are void of resin coating 212 and jacket layer 50, 60 material. A top surface 51 of the first jacket layer 50 and a bottom surface 62 of the second jacket layer 60 define contact surfaces of the composite elevator belt 100 and are configured for tractive, frictional engagement with a running surface of a sheave 200 or drive sheave 1200 of the elevator system 1000.

FIG. 19 depicts a composite elevator belt 100 according to an embodiment of the present disclosure. The composite elevator belt 100 includes at least one fiber or strand 211 encased in a resin coating 212 and extending in a longitudinal direction L of the composite elevator belt 100 to form a load carrier 200. The at least one fiber or strand 211 may be continuous along the length of the composite elevator belt 100. The load carrier strands 211 in this embodiment are arranged in an ordered pattern. The strands 211 are positioned side-by-side at their widest part. This positioning allows for an inter-strand space 23 free of load carrier strands to be provided between the load carrier strands 211. The inter-strand space 23 forms a straight continuous channel which travels from a first terminal end 24 of the load carrier 26 to an opposite terminal end 25 of the load carrier 200. In this particular example, there is no space 23 in the thickness direction. Such an arrangement of strands 211 facilitates a controlled buckling of the elevator belt 100 and serves to enhance its bending performance. A first plurality of teeth 30 is disposed on a top surface 21 of the resin coating 212 and extends outwardly therefrom. Each of the first plurality of teeth 30 has a root portion 32 associated with the resin coating 212 and a tip portion 33 extending from the root portion 32 away from the resin coating 212. Each of the first plurality of teeth 30 further includes a pair of flank surfaces 31 extending along the top surface 21 (not shown) of the resin coating 212 in a direction not parallel to and, in some embodiments, substantially perpendicular to the longitudinal direction L. The space between adjacent teeth 30 form grooves associated with top surface 21 the resin coating 212 (not shown). Similarly, a second plurality of teeth 40 is disposed on a bottom surface 22 (not shown) of the resin coating 212 and extends outwardly therefrom. Each of the second plurality of teeth 40 has a root portion 42 associated with the resin coating 212 and a tip portion 43 extending from the root portion 42 away from the resin coating 212. Each of the second plurality of teeth 40 has a pair of flank surfaces 41 (not shown) extending along the bottom surface 22 of the resin coating 212 in a direction not parallel to and, in some embodiments, substantially perpendicular to the longitudinal direction L. The space between adjacent teeth 40 form grooves associated with bottom surface 22 of the resin coating 212 (not shown). Together, the strands 211, resin coating 212, and first and second pluralities of teeth 30, 40 define the load carrier 200 that carries tension in the longitudinal direction L when the composite elevator belt 100 is in operation supporting a component of an elevator system 1000 (see FIG. 9).

A first jacket layer 50 is provided and extends parallel to the resin coating 212 in the longitudinal direction L. The first jacket layer 50 is spaced apart from the resin coating 212 by the first plurality of teeth 30 and is associated with the tip portions 33 of each of the first plurality of teeth 30. Between each adjacent pair of the first plurality of teeth 30, a transverse groove is defined by the top surface 21 of the resin coating 212, a bottom surface 52 of the first jacket layer 50, and the flanks 31 of the adjacent teeth 30. Similarly, a second jacket layer 60 is provided and extends parallel to the resin coating 212 in the longitudinal direction L. The second jacket layer 60 is spaced apart from the resin coating 212 the second plurality of teeth 40 and is associated with the tip portions 43 of each of the second plurality of teeth 40. Between each adjacent pair of the second plurality of teeth 40, a transverse groove is defined by the bottom surface 22 of the resin coating 212, a top surface 61 of the second jacket layer 60, and the flanks 41 of the adjacent teeth 40. These transverse grooves are void of resin coating 212 and jacket layer 50, 60 material. A top surface 51 of the first jacket layer 50 and a bottom surface 62 of the second jacket layer 60 define contact surfaces of the composite elevator belt 100 and are configured for tractive, frictional engagement with a running surface of a sheave 200 or drive sheave 1200 of the elevator system 1000.

The resin coating 212 defines a plurality of deformable cavities 213 interspersed throughout. The plurality of deformable cavities 213 are positioned adjacent to the load carrier strands 211, meaning each of the cavities 213 is spaced apart from the load carrier strands 211, in any direction from the longitudinal axis L, within the resin coating 212. Each of the plurality of cavities 213 encloses a material, which may be a solid, a liquid, or a gas, having a greater deformability than the deformability of the surrounding resin coating 212. The plurality of cavities 213 may account for approximately one third of the total volume of the resin coating 212, although the ratio of the volume of the cavities 213 to the total volume of the resin coating 212 may be adjusted to attain various levels of stress reduction in the composite elevator belt 100, as described in detail with reference to FIG. 5. The cavities 213 are polygonal in shape. The shape of the cavities 213 may be dictated by the method of production of the resin coating 212, as was earlier described. Additionally, the exact spacing and location of each deformable cavity 213 within the resin coating 212 may be a product of inherent variability in the manufacturing process during which the cavities 213 are defined. However, many properties of the cavities 213 may be predetermined despite variabilities in the manufacturing process. For example, the size of the cavities 213 and the ratio of the total volume of the cavities 213 per unit volume of the resin coating 212 may be predetermined and controlled throughout the manufacturing process. As such, the plurality of deformable cavities 213 may be differentiated from unintentionally occurring voids and/or discontinuities that would naturally occur in the resin coating 212. For this reason, the plurality of cavities 213 may be referred to as being predetermined or predefined. In this particular embodiment shown, the cavities 213 are designed within the load carrier 200 so that they possess a symmetry about a first axis A.

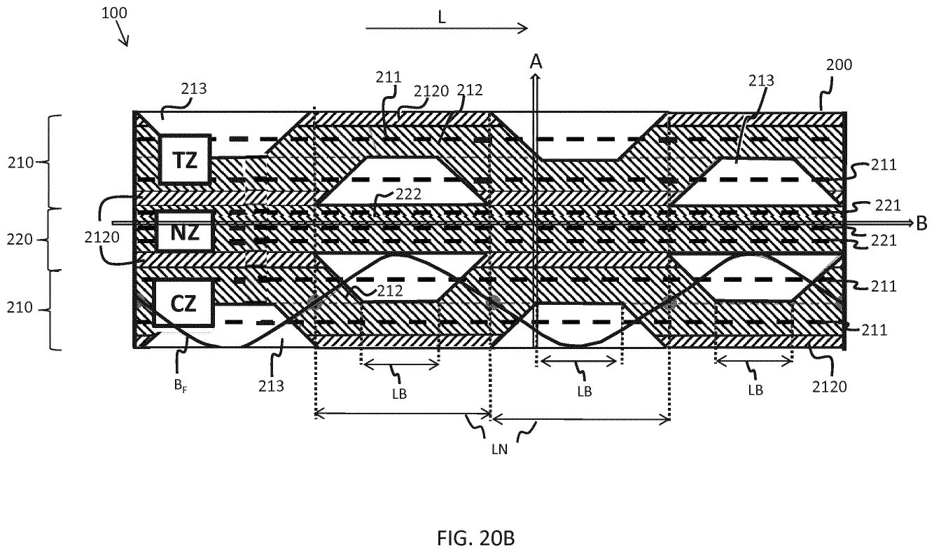

FIGS. 20A and 20B depict a longitudinal cross-section view of a composite elevator belt 100 according to two separate embodiments of the present disclosure. The belt 100 according to each embodiment comprises a load carrier 200. The load carrier 200 provides the tensile strength of the composite elevator belt 100. The composite elevator belt 100 includes multiple load carrier strands 211 arranged parallel to the longitudinal axis L of the composite elevator belt 100. In other embodiments, the load carrier strands 211 may be interrupted along the longitudinal axis L, and may or may not overlap one another. In still other embodiments, the load carrier strands 211 may be arranged in multiple layers spaced apart from one another in a direction perpendicular to the longitudinal axis L. In still other embodiments, the load carrier strands 211 may be entangled, discontinuous fibers arranged in a mat or roving. The load carrier strands 211 may be encased in a resin coating 212 which defines a cross-sectional profile of the outer layer 210 and fills any voids between the load carrier strands 211. The one or more load carrier strands 211 may account for between approximately 30% and approximately 60% of the total volume of each outer layer 210. However, the volume ratio of the load carrier strands 211 to the total volume of each outer layer 210 may be adjusted to balance the strength and flexibility of the composite elevator belt 100 for a particular application. Generally, increasing the volume ratio of the load carrier strands 211 to the total volume of each outer layer 210 increases the strength and decreases the flexibility of the composite elevator belt 100, while decreasing the volume ratio of the load carrier strands 211 to the total volume of each outer layer 210 decreases the strength and increases the flexibility of the composite elevator belt 100.

The central layer 220 may include one or more load carrier strands 221 arranged parallel to and continuous along the longitudinal axis L of the composite elevator belt 100. In other embodiments, the load carrier strands 221 may be interrupted along the longitudinal axis L, and may or may not overlap one another. In still other embodiments, the load carrier strands 221 may be arranged in multiple layers spaced apart from one another in a direction perpendicular to the longitudinal axis L. In still other embodiments, the load carrier strands 221 may be entangled, discontinuous fibers arranged in a mat or roving. The one or more load carrier strands 221 may be encased in a resin coating 222, which defines a cross-sectional profile of the central layer 220 and fills any voids between the load carrier strands 221. The resin coating 222 may be substantially free of any voids or impurities except for those unintentionally introduced during the manufacturing of the central layer 220. The one or more load carrier strands 221 may account for between approximately 60% and approximately 80% of the total volume of the central layer 220. However, the volume ratio of the load carrier strands 221 to the total volume of the central layer 220 may be adjusted to balance the strength and flexibility of the composite elevator belt 100 for a particular application. Generally, increasing the volume ratio of the load carrier strands 221 to the total volume of the central layer 220 increases the strength and decreases the flexibility of the composite elevator belt 100, while decreasing the volume ratio of the load carrier strands 221 to the total volume of the central layer 220 decreases the strength and increases the flexibility of the composite elevator belt 100.

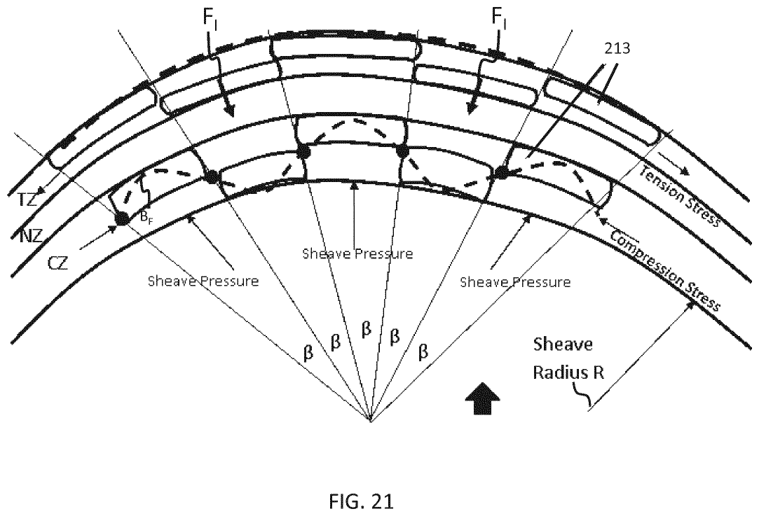

As the at least one outer layer 210 may occupy either the compression zone CZ or the tension zone TZ of the composite elevator belt 100, the at least one outer layer 210 may be subject to greater loads due to bending than the central layer 220, which may be generally coincident with the neutral bending zone NZ. As such, the ratio of the volume of the load carrier strands 211 of each outer layer 210 to the total volume of that outer layer 210 may be less than the ratio of the volume of the load carrier strands 221 of the central layer 220 to the total volume of the central layer 220. The resin coating 212 of each outer layer 210 defines a plurality of deformable cavities 213 interspersed throughout. The plurality of deformable cavities 213 are positioned adjacent to the load carrier strands 211, meaning each of the cavities 213 is spaced apart from the load carrier strands 211, in any direction from the longitudinal axis L, within the resin coating 212. Each of the plurality of cavities 213 encloses a material, which may be a solid, a liquid, or a gas, having a greater deformability than the deformability of the surrounding resin coating 212. The plurality of cavities 213 may account for approximately one third of the total volume of the resin coating 212, although the ratio of the volume of the cavities 213 to the total volume of the resin coating 212 may be adjusted to attain various levels of stress reduction in the composite elevator belt 100, as described in detail with reference to FIG. 5. The cavities 213 are polygonal in shape. The shape of the cavities 213 may be dictated by the method of production of the resin coating 212, as was earlier described. Additionally, the exact spacing and location of each deformable cavity 213 within the resin coating 212 may be a product of inherent variability in the manufacturing process during which the cavities 213 are defined. However, many properties of the cavities 213 may be predetermined despite variabilities in the manufacturing process. For example, the size of the cavities 213 and the ratio of the total volume of the cavities 213 per unit volume of the resin coating 212 may be predetermined and controlled throughout the manufacturing process. As such, the plurality of deformable cavities 213 may be differentiated from unintentionally occurring voids and/or discontinuities that would naturally occur in the resin coating 212. For this reason, the plurality of cavities 213 may be referred to as being predetermined or predefined. In each particular embodiment of FIG. 20A and FIG. 20B, there is an additional layer 2120 between the outer layer 210 and the central layer 220, and an additional layer 2120 on the side of each outer layer non-adjacent to the central layer 220. This additional layer 2120 is optional and comprises the resin coating 212 without any fibers. The cavities 213 have a shorter side length of LB and a longer side length of LN. According to the embodiment shown in FIG. 20A, the cavities 213 are designed within the load carrier 200 so that they possess a symmetry about a first axis A. According to the embodiment shown in FIG. 20B, the cavities 213 are designed within the load carrier 200 so that they possess a symmetry about a first axis A, and a symmetry about a further axis B. It is also envisaged that the elevator belt 100 according to the embodiment shown in FIG. 20A and FIG. 20B, can optionally further comprise at least a first plurality of teeth (not shown). When teeth are incorporated into the belt 100, as the belt 100 bends around a sheave, the curved line, B_{F} represents the load carrier strand when bending in the compression zone CZ. The presence of teeth, their positioning within the belt 100 and their selected dimensions can advantageously achieve a controlled buckling of the load carrier strands 211 in the outer layer 210. The height of the additional layer 2120 is determined by the buckling amplitude of the load carrier strand when bending in the compression zone CZ. The larger the buckling amplitude, the thicker the additional layer. It is advantageous if the fibers can buckle freely without touching the jacket layer or for example, the center layer. The effects of bending are shown more clearly in FIG. 21.

FIG. 21 more clearly demonstrates the stress release in the compression zone CZ and tension zone TZ (shown by their respective arrows). In the tension zone TZ, the fibers (not shown) move inwards shown by arrows F₁ causing a reduction of tensile stress. The compression stress is released due to the controlled fiber buckling B_{F} of the load carrier strand in the compression zone CZ.

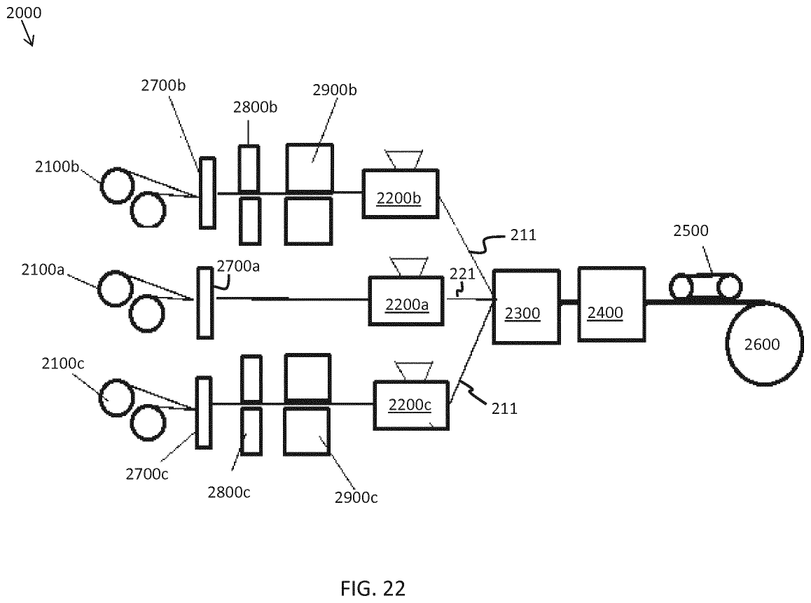

Other embodiments of the present disclosure are directed to a method of manufacturing the composite elevator belt 100 described with reference to FIGS. 1-8 and FIGS. 11A-20B. Referring now to FIG. 22, an apparatus 2000 at least partially forms each of the at least one outer layers 210 and the central layer 220 individually before the at least one outer layer 210 and the central layer 220 are joined in a final forming stage. As shown in FIG. 10, the apparatus 2000 includes a first roving coil rack 2100a associated with the central layer 220, a second roving coil rack 2100b associated with a first of the outer layers 210, and a third roving coil rack 2100c associated with a second of the outer layers 210. The roving coil racks 2100a-2100c hold the load carrier strands 211, 221 for the outer layers 210 and central layer 220, respectively. A first injection chamber 2200a associated with the central layer 220 and the first roving coil rack 2100a contains a bath of liquid resin for forming the resin coating 222 of the central layer 220. The load carrier strands 221 of the central layer 220 are pulled from the first roving coil rack 2100a, through a fiber arranger 2700, wherein the fiber arranger 2700 comprises a first fiber arranger 2700a, a second fiber arranger 2700b, a third fiber arranger 2700c. Each fiber arranger 2700a, 2700b, 2700c, forms a rectangle fiber distribution into a fiber bundle of load carrier strands 221. The load carrier strands 221 of the central layer 220 are pulled from the first roving coil rack 2100a, through the fiber arranger 2700a. The fiber bundle is then pulled through a cavity printer 2800, wherein the cavity printer 2800 comprises a first cavity printer 2800a, a second cavity printer 2800b, a third cavity printer 2800c. The load carrier strands 221 of the central layer 220 are pulled through the cavity printer 2800a. Each cavity printer 2800a, 2800b, 2800c sprays defined amounts of cavity material onto the fiber bundle of load carrier strands 221. The amount of sprayed material depends on the height of the cavity and the speed of the fiber bundle as it makes its way through the cavity printer 2800a, 2800b, 2800c. It also influences the desired impregnation thickness of the spray pattern. Once through the cavity printer 2800b, the fiber bundle of load carrier strands 221 is subjected to cavity curing 2900. Cavity curing comprises a first cavity curing 2900a, a second cavity curing 2900b, a third cavity curing 2900c. The curing of the cavities is preferably carried out via electron beam. The intensity of the electron beam is adjusted according to the curing requirements. The electron beam dims if a cavity gap crosses the beam. After the cavities are cured via first cavity curing 2900a, the fiber bundle of load carrier strands 221 enters a first injection chamber 2200a to impregnate the load carrier strands 221 with liquid resin. Similarly, second and third injection chambers 2200b, 2200c associated with the outer layers 220 and the second and third roving coil racks 2100b, 2100c each contain a bath of liquid resin for forming the resin coating 212 of the outer layers 210. The load carrier strands 211 of the two outer layers 210 are pulled from the second and third roving coil racks 2100b, 2100c and through a fiber arranger 2700b, 2700c respectively. The fiber arranger 2700b, 2700c forms the rectangle fiber distribution into a fiber bundle of load carrier strands 211. The fiber bundle is then pulled through a cavity printer 2800b, 2800c (not shown) respectively. The cavity printer 2800b, 2800c sprays defined amounts of cavity material onto the fiber bundle of load carrier strands 211. The amount of sprayed material depends on the height of the cavity and the speed of the fiber bundle as it makes its way through the cavity printer 2800b, 2800c. It also influences the desired impregnation thickness of the spray pattern. Once through the cavity printer 2800b, 2800c the fiber bundle of load carrier strands 211 is subjected to cavity curing 2900b, 2900c. The curing of the cavities is preferably carried out via electron beam. The intensity of the electron beam is adjusted according to the curing requirements. The electron beam dims if a cavity gap crosses the beam. After the cavities are cured, the fiber bundle of load carrier strands 211 enters the second and third injection chambers 2200b, 2200c, respectively, to impregnate the load carrier strands 211 with liquid resin.

The liquid resin in the second and third injection chambers 2200b, 2200c may be intermixed with an additive suitable for forming the plurality of cavities 213 in the resin coating 212. In some embodiments, the additive may be a blowing agent, such as azodicarbonamide, which decomposes into gas during the subsequent curing of the liquid resin. In other embodiments, the additive may be solid particles, liquid particles, or gas particles. The amount or volume of the chosen additive intermixed with the liquid resin may be governed to control the total volume of the cavities 213 ultimately defined in the finished resin coating 212. Measures may be undertaken to ensure that the additive is homogenously intermixed with the liquid resin so that the cavities 213 are subsequently defined having substantially uniform spacing in the finished resin coating 212. In some embodiments, the load carrier strands 211, 221 may be coated with an additive, such as a blowing agent, prior to being pulled into the injection chambers 2200a, 2200b, 2200c, alternatively or in addition to the additive intermixed with the liquid resin.

After the load carrier strands 211, 221 of the outer layers 210 and the central layer 220 are impregnated with liquid resin, the load carrier strands 211, 221 are pulled out of the injection chambers 2200a-2200c and into a forming and curing die 2300 where the outer layer 210 and central layer 220 are joined together. When entering the forming and curing die 2300, the liquid resin impregnating the load carrier strands 211, 221 remains in an at least partially liquid phase to facilitate adhesion of the outer layers 210 to the central layer 220. Within the forming and curing die 2300, final shaping of the outer layers 210 and the central layer 220 is performed, and the liquid resin impregnating the load carrier strands 211, 221 is cured to form the resin coatings 212, 222 of the outer layers 210 and central layer 220.

Curing of the resin coatings 212, 222 may be achieved, for example, by induction heating of the load carrier strands 211, 221 and/or the liquid resin.

In embodiments of the composite elevator belt 100 in which a blowing agent is intermixed with the liquid resin of the outer layers 210, the forming and curing die 2300 may also provide heat to decompose the blowing agent prior to or concurrently with the curing of the resin coating 212 of the outer layers 210. Decomposition of the blowing agent forms gas pockets around which the cavities 213 of the resin coating 212 are defined as the resin coating 212 cures. Similarly, in embodiments of the composite elevator belt 100 in which solid particles and/or liquid particles are intermixed with the liquid resin of the outer layers 210, the resin coating 212 cures around the liquid particles and/or solid particles to define the cavities 213.

After curing is completed in the forming and curing die 2300, the load carrier 200, now including all of the outer layers 210 and the central layer 220 joined together, may optionally be pulled through a jacket extruder 2400 which deposits the jacket layer 300 onto external surfaces of the load carrier 100. The composite elevator belt 100 exits the jacket extruder 2400 fully formed.

A tractor 2500 located downstream of the jacket extruder 2400 and/or the forming and curing dies 2300 applies a pulling force to unwind the load carrier strands 211, 221 from the roving coil racks 2100a-2100c and pull the load carrier strands 211, 221 through the fiber arrangements 2700a, 2700b, 2700c; the cavity printer; 2800a, 2800b, 2800c; the cavity curing 2900a, 2900b, 2900c; the injection chambers 2200a-2200c; the forming and curing die 2300; and, optionally, the jacket extruder 2400. The finished composite elevator belt 100 is then wound into a spool by a spooler 2600.

Utilizing the apparatus 2000 described above, a method for making a composite elevator belt 100 includes partially forming the at least one outer layer 210 of the load carrier 100 by impregnating the load carrier strands 211 of the at least one outer layer 210 with liquid resin in the second and third injection chambers 2100b, 2100c. The liquid resin in the second and third injection chambers 2100b, 2100c may be intermixed with an additive selected from a group consisting of deformable materials and blowing agents. The central layer 220 of the load carrier 100 may be formed in substantially the same manner as the outer layers 210, namely by impregnating the load carrier strands 221 of the central layer 220 with liquid resin in the first injection chamber 2100a. The outer layers 210 and the central layer 220 may then be pulled from the forming and curing die 2300 to join the outer layers 210 to the central layer 220 and cure the liquid resin of the outer layers 210 and the central layer 220. Curing the liquid resin of the outer layers 210 forms a solid resin coating defining the plurality of cavities 213 around the additive intermixed with the liquid resin.

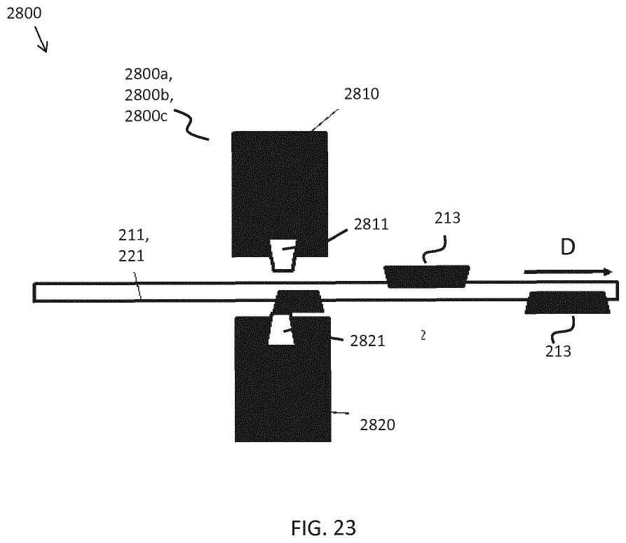

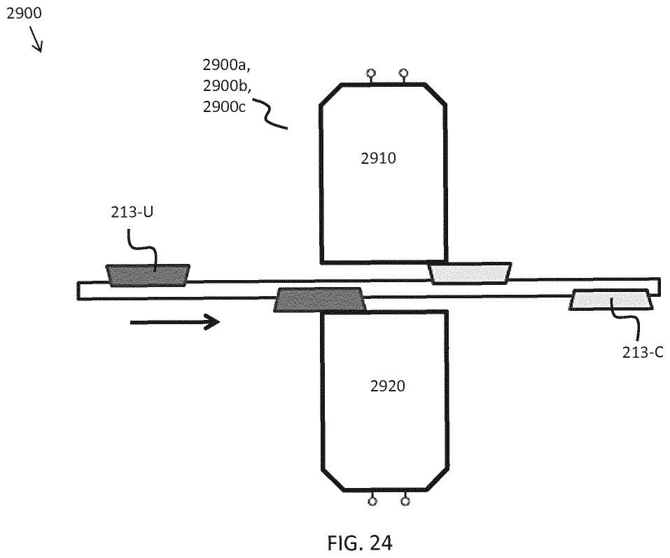

While the apparatus 2000 and method described above provide one embodiment for manufacturing the composite elevator belt 100, variations may be made to suit the requirements of a particular application. For example, the central layer 220, which, in the present embodiment, lacks the plurality of cavities 213 present in the outer layers 210, may be at least partially formed using a different process than the outer layers 210, or the central layer 220 may be pre-manufactured and joined to the partially-formed outer layers 210 in the forming and curing die 2300. In other embodiments, the central layer 220 may be made similarly to the outer layers 210 such that cavities 213 are formed in the central layer 220 in addition to the outer layers 210. In still other embodiments, additional tooling may be added to the apparatus 2000 to perform additional forming operations to the composite elevator belt 100, or to add further layers to the composite elevator belt 100. In still other embodiments, the load carrier 200 may include an outer layer 210 on only one side of the central layer 220, or the load carrier 200 may include multiple outer layers 210 stacked on and joined with each other on any side or sides of central layer 220. FIG. 23 shows in more detail the cavity printer 2800; whilst FIG. 24 shows in more detail the cavity curing 2900. Any cavity printer used in this stage 2800a, 2800b, 2800c comprises two printers 2810, 2820, each printer 2810, 2820 comprising a print head 2811, 2821 respectively, wherein said printers 2810, 2820 are spaced apart in order to allow the passing through of the fiber bundle of load carrier strands 211, 221. The fiber bundle of load carrier strands 211, 221 pass between the printer heads 2811, 2821 at a speed determined by the speed of the tractor 2500 in direction D. Cavity printing creates defined cavities. Cavities are printed in the load carrier strands 211, 221 to create a defined cavity position and shape, so that all strands in the cavity can be impregnated or at least lubricated (e.g., fiber abrasion). After printing the cavities 213 a curing process helps the cavity to stay well shaped even after impregnation for example, using a matrix resin material, as well as after having passed through the forming and curing die 2300 stage.

The cavity curing 2900 shown in FIG. 24 involves the uncured printed cavities 213-U passing through a cavity curing apparatus 2900a, 2900b, 2900c in order to cure the cavities 213-C in the fiber bundle of load carrier strands 211, 221. The curing of the cavities is preferably carried out via electron beam. The passing through fiber bundle of load carrier strands 211, 221 is exposed to an electron beam from at least a first electron gun 2910 and a second electron gun 2920. It is preferred that primarily the uncured printed cavities 213-U are exposed to the electron beam rather than the fiber bundle. Therefore, a first electron beam from a first electron gun and a second electron beam from a second electron gun preferably are only applied simultaneously if the uncured printed cavities 213-U on both sides of the fiber bundle are exposed to the electron beam(s) at the same time. FIG. 24 shows two beams at the same position in the belt moving direction and the uncured and cured printed cavities 213-U, 213-C respectively at different positions. Both electron beams could work simultaneously if the distance of the beams in the fiber bundle moving direction is equal to the distance of the uncured/cured printed cavities 213-U, 213-C on both sides of the fiber bundle. The intensity of the electron beam is adjusted according to the curing requirements. The electron beam dims if a cavity gap crosses the beam. The fiber bundle is preferably not exposed unnecessarily to the electron beam, as this could create unwanted molecular changes within the fibers. However, the printed cavities themselves can undergo a molecular change, in particular, cross-linking, as this helps to create a strongly accelerated curing process. Conventional curing processes, e.g. with heat, are too slow and lengthen the pultrusion line significantly.

While several examples of a composite elevator belt for an elevator system, as well as methods for making the same, are shown in the accompanying figures and described in detail hereinabove, other examples will be apparent to and readily made by those skilled in the art without departing from the scope and spirit of the present disclosure. For example, it is to be understood that aspects of the various embodiments described hereinabove may be combined with aspects of other embodiments while still falling within the scope of the present disclosure. Accordingly, the foregoing description is intended to be illustrative rather than restrictive. The assembly of the present disclosure described hereinabove is defined by the appended claims, and all changes to the disclosed assembly that fall within the meaning and range of equivalency of the claims are to be embraced within their scope.

1. (canceled)

2. A composite elevator belt for engaging a sheave, the composite elevator belt comprising:
a load carrier comprising at least one load carrier strand, in particular, a plurality of load carrier strands, extending substantially parallel to a longitudinal axis of the load carrier; and
a resin coating surrounding the at least one load carrier strand and defining a plurality of predetermined, deformable cavities within the resin coating adjacent the at least one strand;
wherein, when the elevator belt is bent around the sheave, the elevator belt defines a neutral bending zone located within the elevator belt generally coincident with the longitudinal axis, a tension zone radially outward of the neutral bending zone, and a compression zone radially inward from the neutral bending zone;
wherein the plurality of load carrier strands are arranged such that a space free of load carrier strands is provided between the load carrier strands; wherein the space forms a straight continuous channel which travels from a first terminal end of the load carrier to an opposite terminal end of the load carrier.

3.-5. (canceled)

6. The composite elevator belt of claim 2 wherein a plurality of spaces free of load carrier strands is provided throughout the load carrier and wherein each space forms a straight continuous channel which travels from a first terminal end of the load carrier to an opposite terminal end of the load carrier.

7. The composite elevator belt of claim 2, wherein the plurality of load carrier strands are arranged into a plurality of groups.

8. The composite elevator belt of claim 7, wherein each group is encased with a further material.

9. The composite elevator belt of claim 8, wherein the further material is selected from the group comprising: a sizing material, a polymer material, a silicon material, or a combination of any thereof.

10. The composite elevator belt of claim 2, wherein the space covers a distance of between 0 μm to 50 μm.

11. The composite elevator belt of claim 2, wherein the load carrier strand has a diameter in the range of 2 μm to 20 μm.

12. The composite elevator belt of claim 2, wherein the space can be adapted to cover varying distances throughout the cross-section of the load carrier.

13. The composite elevator belt of claim 2, wherein, when the elevator belt is bent around the sheave, the deformable cavities in the tension zone lengthen longitudinally relative to the longitudinal axis and retract radially relative to the longitudinal axis, and
wherein, when the elevator belt is bent around the sheave, the deformable cavities in the compression zone shorten longitudinally relative to the longitudinal axis and lengthen radially relative to the longitudinal axis.

14. The composite elevator belt of claim 2, wherein the load carrier comprises a plurality of load carrier strands, the plurality of load carrier strands comprising a first load carrier strand located in the tension zone and a second load carrier strand located in the compression zone.

15. The composite elevator belt of claim 14, wherein the first load carrier strand and the second load carrier strand each extend generally parallel to the longitudinal axis.

16. The composite elevator belt of claim 14, wherein, when the elevator belt is bent around the sheave, the first load carrier strand is tensioned in a direction generally parallel to the longitudinal axis and the deformable cavities adjacent the first load carrier strand lengthen longitudinally in a direction generally parallel to the first load carrier strand and shorten radially in the direction generally perpendicular to the first load carrier strand to reposition the first load carrier strand radially closer to the neutral bending zone.

17. The composite elevator belt of claim 14, wherein, when the elevator belt is bent around the sheave, the deformable cavities adjacent the second load carrier strand shorten longitudinally in a direction generally parallel to the first load carrier strand and lengthen radially in the direction generally perpendicular to the first load carrier strand inducing the second load carrier strand to deform into an undulating curve.

18.-19. (canceled)

20. The composite elevator belt of claim 2, wherein each of the plurality of cavities encloses one of a gas, a liquid, and a deformable solid.

21. The composite elevator belt of claim 2, wherein a diameter of each of the plurality of cavities is between one-half and two times the diameter of the at least one load carrier strand.

22. The composite elevator belt of claim 2, wherein the at least one load carrier strand is non-continuous.

23. The composite elevator belt of claim 2, wherein the combined Young's modulus of the resin coating including the plurality of cavities is less than approximately 2 gigapascals.

24. The composite elevator belt of claim 2, wherein a total volume of the plurality of cavities in the compression zone is substantially equal to one third of a total volume of the resin coating, including the total volume of the plurality of cavities, in the compression zone.

25. The composite elevator belt of claim 2, further comprising a jacket layer disposed on the load carrier.

26.-43. (canceled)
